(19) United States
(12) Patent Application Publication
(10) Pub. No.: US 2008/0160356 A1
(43) Pub. Date: Jul. 3, 2008

(54) Metal-Organic Solids for Use in Proton Exchange Membranes

(76) Inventors: George Kisa Hayashi Shimizu, Calgaray (CA); Jeffrey Allen Hurd, Calgary (CA); Ramanathan Vaidhyanathan, Calgary (CA); Jared Michael Taylor, Calgary (CA)

Correspondence Address: FISH & RICHARDSON P.C., PO BOX 1022, MINNEAPOLIS, MN, 55440-1022, US

(21) Appl. No.: 11/953,827

(22) Filed: Dec. 10, 2007

Related U.S. Application Data
(60) Provisional application No. 60/873,935, filed on Dec. 8, 2006.
(60) Provisional application No. 60/973,642, filed on Sep. 19, 2007.

(51) Int. Cl. H01M 8/10; H01B 1/12

(52) U.S. Cl. 429/13; 252/514; 252/513; 252/512

(57) ABSTRACT

Methods for making and using metal-organic solids for use in proton exchange membranes. These proton exchange membranes may also be used in fuel cell applications.

### CROSS-REFERENCE TO RELATED APPLICATIONS

This application claims priority under 35 U.S.C. § 119(e) to U.S. Provisional Application No. 60/973,642, filed on Sep. 19, 2007 and U.S. Provisional Application No. 60/873,935, filed on Dec. 8, 2006, both of which are incorporated by reference in their entirety hereto.

### TECHNICAL FIELD

This disclosure relates to metal-organic solids for use in proton exchange membranes. Included are proton exchange membrane compositions as well as methods of making and uses thereof.

### BACKGROUND

Fuel cells can be described as having two electrodes, an anode and cathode, supported by an electrolyte material that transfers ions to compensate for the flowing electric current. In fuel cells powered by hydrogen or methanol, the electrolyte (membrane) material transfers protons from the anode to the cathode where the protons combine with oxygen to form water. The membrane has two key functions: to transfer protons from the anode to the cathode and to physically separate the hydrogen (or methanol) fuel from the oxidant air to maintain operational integrity. Fuel cells which utilize these types of membranes are referred to as proton exchange membrane (PEM) and direct methanol (DMFC) fuel cells.

The majority of current research on proton exchange membrane materials concerns the use of organic polymers with pendant functionalities that either pass protons or can hydrogen bond with water to facilitate the passage of protons. Typically, these are long chain sulfonic acid or imidazolium type materials with the most common ionomers being the Nafion family of membranes. Some of the concerns associated with proton exchange membranes of this family are water management (i.e., maintaining hydration of the membrane so proton conduction levels are retained), fuel crossover, and high cost.

The properties of a proton exchange membrane significantly influence proton exchange membrane fuel cell performance. Problems with currently available membranes (such as those composed of long chain perfluorosulfonic acid polymers) include low thermal stability, especially under acidic conditions, and loss of proton conductivity at temperatures above 100° C. In addition to the problems of current membranes, the overall efficiency of proton exchange membrane fuel cells is limited by the kinetics of the anode reaction. One way to improve anode efficiency is to operate fuel cells at higher temperatures (e.g., 130° C. versus 75° C.). An increase in temperature would also decrease poisoning of the electrodes by carbon monoxide, an unavoidable by-product of any hydrocarbon reforming process. Therefore, there is a need for improved proton exchange membranes having improved stability and performance.

### SUMMARY

Provided herein are proton exchange membranes comprising metal-organic solids. In one embodiment, the metal-organic solid can comprise a salt of: 1) a metal cation and 2) a compound having the formula:

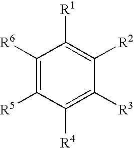

wherein R¹, R², R³, R⁴, R⁵, and R⁶ are independently selected from H, OR⁷, NR⁷R⁸, SR⁷, CO₂H, SO₃H, PO₃H₂, PR⁷R⁸, (CH₂)ₙOR⁷, (CH₂)ₙNR⁷R⁸, (CH₂)ₙSR⁷, (CH₂)ₙCO₂H, (CH₂)ₙSO₃H, (CH₂)ₙPO₃H₂, and R⁹, or any two adjacent R groups come together to form a substituted or unsubstituted fused ring; R⁷ and R⁸ are independently H, C₁-C₁₀ alkyl, C₂-C₁₀ alkenyl, C₂-C₁₀ alkynyl, or aryl; R⁹ is a compound having the formula:

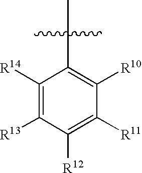

wherein R¹⁰, R¹¹, R¹², R¹³, and R¹⁴ are independently selected from H, OR⁷, NR⁷R⁸, SR⁷, CO₂H, SO₃H, PO₃H₂, (CH₂)ₙOR⁷, (CH₂)ₙNR⁷R⁸, (CH₂)ₙSR⁷, (CH₂)ₙCO₂H, (CH₂)ₙSO₃H, (CH₂)ₙPO₃H₂; n is an integer from 1 to 6; and provided that the compound comprises at least one acidic proton (e.g., one acidic proton, two acidic protons, three acidic protons, or four acidic protons). In some embodiments, R¹-R⁶ are independently selected from H, OR⁷SO₃H, and PO₃H₂. In other embodiments, R¹⁰-R¹⁴ are independently selected from H, OR⁷, SO₃H, and PO₃H₂.

In another embodiment, the metal-organic solid can comprise a salt of: 1) a metal cation and 2) a compound having the formula:

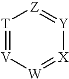

wherein Z is selected from CR¹, N, and NR¹⁵; Y is selected from CR², N, and NR¹⁶; X is selected from CR³, N, and NR¹⁷; W is selected from CR⁴, N, and NR¹⁸; V is selected from CR⁵, N, and NR¹⁹; T is selected from CR⁶, N, and NR²⁰; R¹, R², R³, R⁴, R⁵, and R⁶ are independently selected from H, OR⁷, NR⁷R⁸, SR⁷, CO₂H, SO₃H, PO₃H₂, (CH₂)ₙOR⁷, (CH₂)ₙNR⁷R⁸, (CH₂)ₙSR⁷, (CH₂)ₙCO₂H, (CH₂)ₙSO₃H, (CH₂)ₙPO₃H₂, and R⁹, or any two adjacent R groups come together to form a substituted or unsubstituted fused ring; R⁷ and R⁸ are independently H, C₁-C₁₀ alkyl, C₂-C₁₀ alkenyl, or C₂-C₁₀ alkynyl; R⁹ is a compound having the formula:

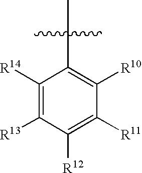

wherein R¹⁰, R¹¹, R¹², R¹³, and R¹⁴ are independently selected from H, OR⁷, NR⁷R⁸, SR⁷, CO₂H, SO₃H, PO₃H₂, (CH₂)ₙOR⁷, (CH₂)ₙNR⁷R⁸, (CH₂)ₙSR⁷, (CH₂)ₙCO₂H, (CH₂)ₙSO₃H, (CH₂)ₙPO₃H₂; n is an integer from 1 to 6; R¹⁵, R¹⁶, R¹⁷, R¹⁸, R¹⁹, and R²⁰ are independently selected from H, C₁-C₁₀ alkyl, C₂-C₁₀ alkenyl, or C₂-C₁₀ alkynyl; and wherein at least one of Z, Y, X, W, V, or T is N or the corresponding NR moiety; and provided that the compound comprises at least one acidic proton. In some embodiments, R¹-R⁶ are independently selected from H, OR⁷, SO₃H, and PO₃H₂. In other embodiments, R¹⁰-R¹⁴ are independently selected from H, OR⁷, SO₃H, and PO₃H₂.

In another embodiment, the metal-organic solid can comprise a salt of: 1) a metal cation and 2) a compound having the formula:

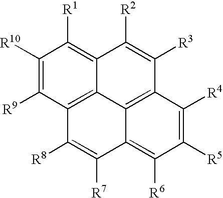

wherein R¹, R², R³, R⁴, R⁵, R⁶, R⁷, R⁸, R⁹, and R¹⁰ are independently selected from H, OR¹¹, NR¹¹R¹², SR¹¹, CO₂H, SO₃H, PO₃H₂, PR¹¹R¹²; (CH₂)ₙOR¹¹, (CH₂)ₙNR¹¹R¹², (CH₂)ₙSR¹¹, (CH₂)ₙCO₂H, (CH₂)ₙSO₃H, and (CH₂)ₙPO₃H₂; R¹¹ and R¹² are independently H, C₁-C₁₀ alkyl, C₂-C₁₀ alkenyl, C₂-C₁₀ alkynyl; or aryl; n is an integer from 1 to 6; and wherein the compound comprises at least one acidic proton. In certain embodiments, R¹-R¹⁰ are independently selected from H, OR⁷, SO₃H, and PO₃H₂.

The metal cation included in the metal-organic solid can be selected from one or more of Li⁺, Na⁺, K⁺, Rb⁺, Cs⁺, Mg²⁺, Ca²⁺, Sr²⁺, Ba²⁺, Sc³⁺, Y³⁺, La³⁺, Ce⁴⁺, Ce³⁺, Pr³⁺, Nd³⁺, SM³⁺, Eu³⁺, Gd³⁺, Tb³⁺, Dy³⁺, Ti⁴⁺, Ti³⁺, Zr⁴⁺, Hf⁴⁺, V⁴⁺, V³⁺, V²⁺, Nb³⁺, Ta³⁺, Cr⁺, Mo³⁺, Mo²⁺, W³⁺, Mn³⁺, Mn²⁺, Re³⁺, Re²⁺, Fe⁴⁺, Fe³⁺, Fe²⁺, Ru³⁺, Ru²⁺, OS³⁺, Os²⁺, Co³⁺, Co²⁺, Rh³⁺, Rh²⁺, Rh³⁺, R³⁺, R²⁺, Ir²⁺, Ni²⁺, Ni⁺, Pd²⁺, Pd⁴⁺, Pd⁺, Pt⁴⁺, Pt²⁺, Pt⁺, Cu²⁺, Cu⁺, Ag⁺, Au⁺, Zn²⁺, Cd²⁺, Hg²⁺, Al³⁺, Ga³⁺, In³⁺, Tl³⁺, Si⁴⁺, Si²⁺, Ge⁴⁺, Ge⁴⁺, Sn⁴⁺, Sn²⁺, Pb⁴⁺, Pb²⁺, As⁵⁺, As³⁺, As⁺, Sb⁵⁺, Sb³⁺, Sb⁺, Bi⁵⁺, Bi³⁺, and Bi⁺. In certain embodiments, the metal cation can be selected from one or more of Na⁺, Cs⁺, K⁺, Ca²⁺, Sr²⁺, Ba²⁺, Zn²⁺, Al³⁺, Ti⁴⁺, and Cu²⁺. In other embodiments, the metal cation is Na⁺ and/or Cs⁺.

In further embodiments, a proton exchange membrane can also contain a dopant. This dopant can include one or more compounds selected from an N-heterocycle and an oxoacid. Examples of an N-heterocycle include substituted or unsubstituted: cyclic amine (e.g., a five- or six-member ring system), lactam, imidazolidone, oxazolidinone, hydantoin, pyrrole, imidazole, benzimidazole, pyrazole, 1,2,3-triazole, 1,2,4-triazole, triazine, tetrazole, oxazole, benzoxazole, isoxazole, thiazole, benzothiazole, 1,3,4-thiadiazole, indole, carbozole, oxindole, 7-azaindole, dihydropyridine, pyridine, quinoline, pyrazine, piperazine, purine and pyrimidine. In some embodiments, the N-heterocycle is selected from substituted or unsubstituted: 1,2,4-triazole, 1,2,3-triazole, tetrazole, imidazole, and pyrazole. In another embodiment, the dopant comprises an N-heterocyclic polymer.

Examples of an oxoacid can include sulfuric acid, sulfurous acid, nitric acid, nitrous acid, phosphoric acid, phosphorous acid, hypophosphorous acid, selenic acid, selenous acid, chromic acid, chromous acid, arsenic acid, arsenous acid, hypoarsenous acid, periodic acid, iodic acid, iodous acid, perbromic acid, bromic acid, bromous acid, perchloric acid, chloric acid, and chlorous acid.

In addition, in some cases, a proton exchange membrane can further comprise a polymer.

A proton exchange membrane comprising a metal-organic solid, as described above, can contain pores. These pores can range from about 3 to about 25 Å. In certain embodiments, the pores can range from about 7 to about 10 Å. Furthermore, a proton exchange membrane can be capable of conducting protons at temperatures from about 25° C. to about 250° C., or from about 100° C. to about 150° C. In some embodiments, the metal-organic solid of a proton exchange membrane can be crystalline, planar, or contain solvent molecules.

Proton exchange membranes comprising a metal-organic solid, as described herein, can be prepared by providing a compound of the formula:

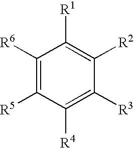

wherein R¹, R², R³, R⁴, R⁵, and R⁶ are independently selected from H, OR⁷, NR⁷R⁸, SR⁷, CO₂H, (CH₂)ₙOR⁷, (CH₂)ₙNR⁷R⁸, (CH₂)ₙSR⁷, (CH₂)ₙCO₂H, and R⁹, or any two adjacent R groups come together to form a substituted or unsubstituted fused ring; R⁷ and R⁸ are independently H, C₁-C₁₀ alkyl, C₂-C₁₀ alkenyl, or C₂-C₁₀ alkynyl; R⁹ is a compound having the formula:

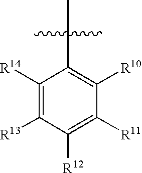

wherein R¹⁰, R¹¹, R¹², R¹³, and R¹⁴ are independently selected from H, OR⁷, NR⁷R⁸, SR⁷, CO₂H, (CH₂)ₙOR⁷, (CH₂)ₙNR⁷R⁸, (CH₂)ₙSR⁷, (CH₂)ₙCO₂H; and n is an integer from 1 to 6. This compound can then be reacted with a halogenated oxoacid. In certain embodiments, the halogenated oxoacid is a chlorinated oxoacid.

Following reaction with a halogenated oxoacid, the reaction product can be combined with a metal salt. Examples of metal salts can include a metal carbonate, metal halide, metal sulfate, metal phosphate, metal oxide, metal hydroxide, metal acetate, metal nitrate, metal tetrafluoroborate, metal hexafluorophosphate, metal organosulfonate, or metal organophosphonate.

In further embodiments, prior to addition of a metal salt, a dopant can be added to the reaction product. Alternatively, a dopant can be added following the addition of the metal salt.

Fuel cells can be prepared which contain a proton exchange membrane as described herein. The proton exchange membrane can function to transfer protons from an anode to a cathode. Therefore, it can be located in a position within the fuel cell wherein the proton exchange membrane is capable of transferring protons from the anode to the cathode. The transference of protons using a proton exchange membrane can occur during operation of the fuel cell.

The details of one or more embodiments of the invention are set forth in the accompanying drawings and the description below. Other features, objects, and advantages of the invention will be apparent from the description and drawings, and from the claims.

All publications, patent applications, patents, and other references mentioned herein are incorporated by reference in their entirety. In case of conflict, the present specification, including definitions, will control. In addition, the materials, methods, and examples are illustrative only and not intended to be limiting.

### DESCRIPTION OF DRAWINGS

FIG. 1 is a representation of the single crystal X-ray structure of Na₃PGS (1A). FIGS. 1B and 1C displays a space filling diagram of Na₃PGS, detailing the channels (1B) created by the pores within the complex and an overhead view of a layer of complexes (1C).

FIG. 2 illustrates an X-ray structure diagram of ZnDHP (2A) with FIG. 2B displaying the structure using a space-filling model.

FIG. 3 displays an X-ray structure diagram of CaDHP.

FIG. 4 shows an X-ray structure diagram of H₈TMPB.

FIG. 5 is a representation of an X-ray structure of ZnTMPB with water-filled channels.

FIG. 6 is an X-ray structure diagram of CaTMPB with a view of a layer of the metal-organic solid. There are no channels in this structure, but the configuration of the compounds within the layers could allow for the transportation of protons with the addition of a dopant.

FIG. 7 illustrates an X-ray structure diagram of SrTMPB.

FIG. 8 displays an X-ray structure diagram of BaTMPB.

FIG. 9 shows an X-ray structure diagram of EuTMPB with a view of a layer of the metal-organic solid. There are no channels in this structure, but the configuration of the compounds within the layers could allow for the transportation of protons with the addition of a dopant.

FIG. 10 is an impedance analysis of Na₃PGS ((1), α-PCMOF-1) in air (A) compared to a humidified N₂ atmosphere (B). (C) is an Arrhenius plot comparing the conductivity of (1) in air and a humidified N₂ atmosphere, RH=47%.

### DETAILED DESCRIPTION

Provided herein are proton exchange membranes comprising metal-organic solids. A proton exchange membrane has two key functions: to transfer protons from the anode to the cathode and to physically separate the hydrogen (or methanol) fuel from the oxidant air to maintain operational integrity. In general, a proton exchange membrane includes a metal-organic solid having pores lined with acidic groups, and may be able to conduct protons at temperatures greater than 100° C. In certain embodiments, the proton exchange membrane may be able to conduct protons at temperatures greater than 150° C.

Metal-organic solids comprise, generically, a metal ion and an organic ligand. The structures of metal-organic solids can be perceived as zeolite-like structures where the oxide anion is replaced by an organic molecule allowing for larger pores in the porous solids. In some embodiments, the pores of the metal-organic solid may be less than 8 Å in diameter. These pores can be optionally occupied or modified leading to a breadth of structures and functions. In some cases, a non-volatile proton carrier molecule (dopant) may be contained within the pores of the metal-organic solid.

### Proton Exchange Membrane Compositions

In one embodiment, proton exchange membranes of the present disclosure can include a metal organic solid comprising the salt of: 1) a metal and 2) a compound of the formula (I):

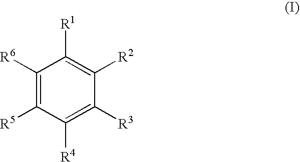

wherein R¹, R², R³, R⁴, R⁵, and R⁶ are independently selected from H, OR⁷, NR⁷R⁸, SR⁷, CO₂H, SO₃H, PO₃H₂, PR⁷R⁸, (CH₂)ₙOR⁷, (CH₂)ₙNR⁷R⁸, (CH₂)ₙSR⁷, (CH₂)ₙCO₂H, (CH₂)ₙSO₃H, (CH₂)ₙPO₃H₂, and R⁹, or any two adjacent R groups come together to form a substituted or unsubstituted fused ring; R⁷ and R⁸ are independently H, C₁-C₁₀ alkyl, C₂-C₁₀ alkenyl, C₂-C₁₀ alkynyl, or aryl; R⁹ can be a compound having the formula (II):

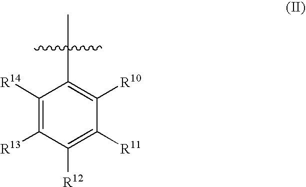

wherein R¹⁰, R¹¹, R¹², R¹³, and R¹⁴ are independently selected from H, OR⁷, NR⁷R⁸, SR⁷, CO₂H, SO₃H, PO₃H₂, (CH₂)ₙOR⁷, (CH₂)ₙNR⁷R⁸, (CH₂)ₙSR⁷, (CH₂)ₙCO₂H, (CH₂)ₙSO₃H, (CH₂)ₙPO₃H₂; n is an integer from 1 to 6; and wherein the compound comprises at least one acidic proton.

Examples can include compounds where: 1) R¹, R³, and R⁵ are SO₃H, and R², and R⁴, and R⁶ are OH; 2) R¹, R³, and R⁵ are PO₃H₂, and R², and R⁴, and R⁶ are OH; 3) R¹, R³, and R⁵ are CH₂SO₃H, and R², R⁴, and R⁶ are OH; 4) R¹ and R⁴ are H, and R², R³, R⁵, and R⁶ are CH₂SO₃H; 5) R¹ is OH, R² is SO₃H, R³, R⁵, and R⁶ are H, R⁴ is R⁹, R¹¹ is SO₃H, R¹² is OH and R¹⁰, R¹³ and R¹⁴ are H; 6) R¹ is OH, R² and R⁶ are SO₃H, R³ and R⁵ are H, R⁴ is R⁹, R¹¹ and R¹³ are SO₃H, R¹² is OH, and R¹⁰ and R¹⁴ are H; 7) R¹, R³, and R⁵ are R⁹, R², R⁴, and R⁶ are H, R¹⁰ and R¹⁴ are SO₃H, R¹¹ and R¹³ are H, and R¹² is PO₃H₂; and 8) R¹ is SO₃H, R² and R³ come together to form a fused aryl ring substituted by SO₃H and OH, R⁴ and R⁵ are H, and R⁶ is OH.

Non-limiting examples of compounds according to formula (I) include:

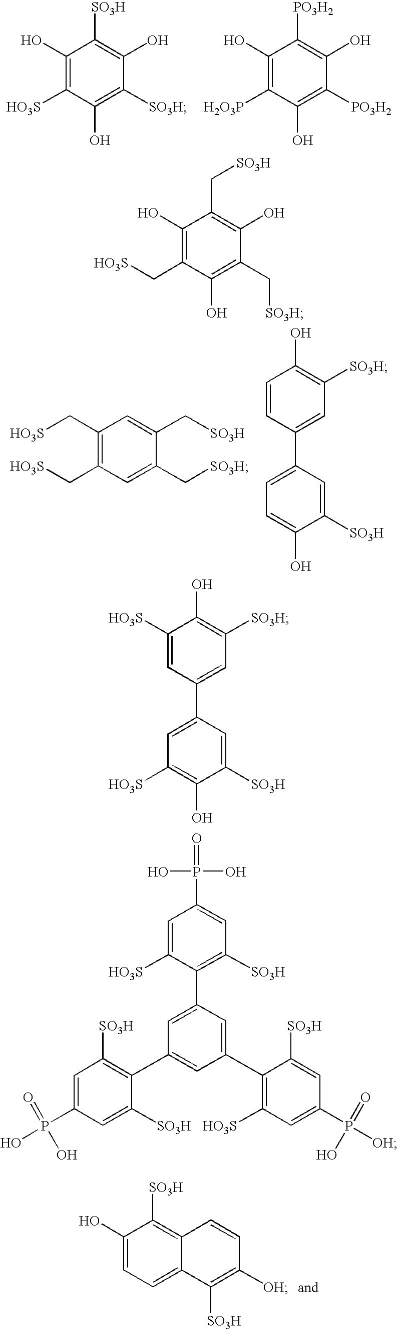

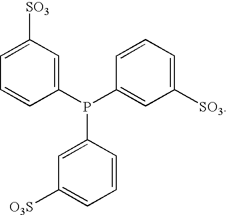

In another embodiment, a proton exchange membrane can include a salt of: 1) a metal cation and 2) a compound having the formula (III):

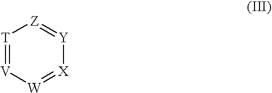

wherein Z is selected from CR¹, N, and NR¹⁵; Y is selected from CR², N, and NR¹⁶; X is selected from CR³, N, and NR¹⁷; W is selected from CR⁴, N, and NR¹⁸; V is selected from CR⁵, N, and NR¹⁹; T is selected from CR⁶, N, and NR²⁰; R¹, R², R³, R⁴, R⁵, and R⁶ are independently selected from H, OR⁷, NR⁷R⁸, SR⁷, CO₂H, SO₃H, PO₃H₂, (CH₂)ₙOR⁷, (CH₂)ₙNR⁷R⁸, (CH₂)ₙSR⁷, (CH₂)ₙCO₂H, (CH₂)ₙSO₃H, (CH₂)ₙPO₃H₂, and R⁹, or any two adjacent R groups come together to form a substituted or unsubstituted fused ring; R⁷ and R⁸ are independently H, C₁-C₁₀ alkyl, C₂-C₁₀ alkenyl, or C₂-C₁₀ alkynyl; R⁹ is a compound having the formula (IV):

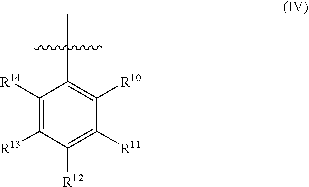

wherein R¹⁰, R¹¹, R¹², R¹³, and R¹⁴ are independently selected from H, OR⁷, NR⁷R⁸, SR⁷, CO₂H, SO₃H, PO₃H₂, (CH₂)ₙOR⁷, (CH₂)ₙNR⁷R⁸, (CH₂)ₙSR⁷, (CH₂)ₙCO₂H, (CH₂)ₙSO₃H, (CH₂)ₙPO₃H₂; n is an integer from 1 to 6; R¹⁵, R¹⁶, R¹⁷, R¹⁸, R¹⁹, and R²⁰ are independently selected from H, C₁-C₁₀ alkyl, C₂-C₁₀ alkenyl, or C₂-C₁₀ alkynyl; wherein at least one of Z, Y, X, W, V, or T is N or the corresponding NR moiety; and wherein the compound comprises at least one acidic proton.

In another embodiment, the metal-organic solid can comprise a salt of: 1) a metal cation and 2) a compound having the formula (V):

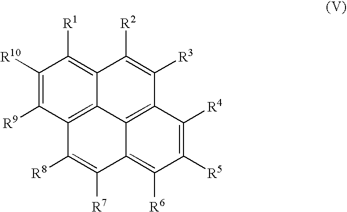

wherein R¹, R², R³, R⁴, R⁵, R⁶, R⁷, R⁸, R⁹, and R¹⁰ are independently selected from H, OR¹¹, NR¹¹R¹², SR¹¹, CO₂H, SO₃H, PO₃H₂, PR¹¹R¹²; (CH₂)ₙOR¹¹, (CH₂)ₙNR¹¹R¹², (CH₂)ₙSR¹¹, (CH₂)ₙCO₂H, (CH₂)ₙSO₃H, and (CH₂)ₙPO₃H₂; R¹¹ and R¹² are independently H, C₁-C₁₀ alkyl, C₂-C₁₀ alkenyl, C₂-C₁₀ alkynyl; or aryl; n is an integer from 1 to 6; and wherein the compound comprises at least one acidic proton. In certain embodiments, R¹-R¹⁰ are independently selected from H, OR⁷, SO₃H, and PO₃H₂.

One example of a compound of formula V is:

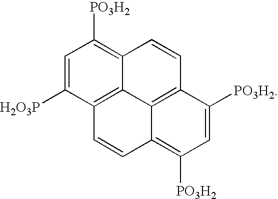

In some embodiments, the compounds described above can be crystalline networks that exist as both a low temperature (α) phase and a high temperature (β) phase. Significant structural rearrangement is required to convert between the α and β phases.

In certain embodiments, an alkyl, alkenyl, or alkynyl group can be substituted or unsubstituted. When a substituent contains an acidic proton, the substituent may be protonated or unprotonated, depending on whether or not the substituent is involved in metal binding and/or the conditions under which the compound is used (e.g., pH of an aqueous solution). Furthermore, when more than one substituent contains an acidic proton, the substituents may exist in a mixture of protonated and unprotonated states, for example, PO₃H₂ and PO₃H⁻ may both be present on the same molecule.

A compound of formula (I), (III), or (V) can be combined with a metal cation to form a metal-organic solid. Any suitable metal cation may be used in the formation of a metal-organic solid. In some embodiments, more than one type of cation may be used (e.g., 2 types of metal cation, 3 types of metal cation, or 4 types of metal cation). Examples of metal cations include: Li⁺, Na⁺, K⁺, Rb⁺, Cs⁺, Mg²⁺, Ca²⁺, Sr²⁺, Ba²⁺, Sc³⁺, Y³⁺, La³⁺, Ce⁴⁺, Ce³⁺, Pr³⁺, Nd³⁺, Sm³⁺, Eu³⁺, Gd³⁺, Tb³⁺, Dy³⁺, Ti⁴⁺, Ti³⁺, Zr⁴⁺, Hf⁴⁺, V⁴⁺, V³⁺, V²⁺, Nb³⁺, Ta³⁺, Cr³⁺, Mo³⁺, Mo²⁺, W³⁺, Mn³⁺, Mn²⁺, Re³⁺, Re²⁺, Fe⁴⁺, Fe³⁺, Fe²⁺, Ru³⁺, Ru²⁺, Os³⁺, Os²⁺, Co³⁺, Co²⁺, Rh³⁺, Rh²⁺, Rh⁺, Ir³⁺, Ir²⁺, Ir⁺, Ni²⁺, Ni⁺, Pd²⁺, Pd⁴⁺, Pd⁺, Pt⁴⁺, Pt²⁺, Pt⁺, Cu²⁺, Cu⁺, Ag⁺, Au⁺, Zn²⁺, Cd²⁺, Hg²⁺, Al³⁺, Ga³⁺, In⁺, Tl³⁺, Si⁴⁺, Si²⁺, Ge⁴⁺, Ge²⁺, Sn⁴⁺, Sn²⁺, Pb⁴⁺, Pb²⁺, As⁵⁺, As³⁺, As⁺, Sb⁵⁺, Sb³⁺, Sb⁺, Bi⁵⁺, Bi³⁺, and Bi⁺. In certain embodiments, the metal cation can be selected from one or more of Na⁺, Cs⁺, K⁺, Ca²⁺, Sr²⁺, Ba²⁺, Zn²⁺, Al³⁺, Ti⁴⁺, and Cu²⁺. In other embodiments, the metal cation may be Na⁺ and/or Cs⁺.

In some embodiments, a metal-organic solid can carry an overall neutral charge. In other embodiments, a metal-organic solid can carry either a positive or negative charge. In addition, in certain embodiments, additional counter cations or counter anions may be present in a metal-organic solid. In additional embodiments, the metal cations can be coordinatingly saturated.

A proton exchange membrane can further comprise a dopant. A dopant may be capable of interacting with a metal-organic solid in the exchange of protons. In some embodiments, more than one dopant may be used within a single proton exchange membrane. In certain embodiments, the dopant is non-volatile. Examples of dopants can include one or more compounds selected from an N-heterocycle and an oxoacid. In certain embodiments, a metal-organic solid can function as a dopant, e.g., when a metal-organic solid is combined with a perfluorosulfonic acid polymer.

Suitable N-heterocycles can include any cyclic ring structure containing a nitrogen moiety. Examples of N-heterocycles include cyclic amine, lactam, imidazolidone, oxazolidinone, hydantoin, pyrrole, imidazole, benzimidazole, pyrazole, 1,2,3-triazole, 1,2,4-triazole, triazine, tetrazole, oxazole, benzoxazole, isoxazole, thiazole, benzothiazole, 1,3,4-thiadiazole, indole, carbozole, oxindole, 7-azaindole, dihydropyridine, pyridine, quinoline, pyrazine, piperazine, purine, and pyrimidine. An N-heterocycle can be substituted or unsubstituted. In some embodiments, the N-heterocycle can be selected from 1,2,4-triazole, 1,2,3-triazole, tetrazole, imidazole, and pyrazole.

In another embodiment, the N-heterocycle can be an N-heterocycle polymer. The polymer can contain from about 2 to about 100 N-heterocycle monomers (e.g., about 2 to about 10, about 3 to about 6, about 10 to about 30, about 15 to about 45, about 20 to about 60, about 30 to about 75, about 40 to about 50, about 60 to about 80, about 75 to about 100, and about 87 to about 99). Examples of N-heterocyclic polymers can include oligopyrroles and oligoimidazoles. See, for example, Morita, Y. et al., Mol. Cryst. Liq. Cryst., 2002, 379: 83-88.

Another type of dopant that may be used with a metal-organic solid is an oxoacid. Examples of oxoacids can include sulfuric acid, sulfurous acid, nitric acid, nitrous acid, phosphoric acid, phosphorous acid, hypophosphorous acid, selenic acid, selenous acid, chromic acid, chromous acid, arsenic acid, arsenous acid, hypoarsenous acid, periodic acid, iodic acid, iodous acid, perbromic acid, bromic acid, bromous acid, perchloric acid, chloric acid, and chlorous acid. In some embodiments, sulfuric acid and/or phosphoric acid can be used as a dopant.

In certain embodiments, a proton exchange membrane can further contain a polymer. This polymer can be a binding polymer, e.g., polyethyleneoxide, polypropylene, polyethylene, polyethylene terephthalate (polyester), nylon 66, polytetrafluoroethylene (Teflon), poly(methyl methacrylate), polyisoprene) (rubber), polychloroprene, poly(vinylacetate), polyacrylonitrile, poly(vinylchloride), poly(vinylidenechloride). A polymer can also be a perfluorosulfonic acid polymer such as Nafion. Further examples of polymers include polybenzimidazole, polypyrrole, sulfonated poly(ether ether ketone), sulfonated polyphosphazenes, sulfonated poly(ethylene-alt-tetrafluoroethylene), poly(arylene thioethilene sulfone), sulfonated polysulfones, sulfonated poly(arylene ether sulfone), sulfonated poly(arylether ketone), polystyrene sulfonate, poly(oxadiazole), poly(diallyldimethylammonium), Dow chemical XUS® membranes, 3P energy membranes, Ballard membranes, Fluorocarbon membranes of Hoku Scientific Inc., and Asahi Glass fluorinated membranes.

In some embodiments, a polymer can be contained within the pores of the metal-organic solid. In other embodiments, the polymer can be combined with the metal-organic solid, but not necessarily contained within the pores. In another embodiment, the metal-organic solid may function as a dopant within a polymer-based proton exchange membrane. In certain embodiments, a proton exchange membrane can include a mixture of a polymer and the components of a metal-organic solid. In such an embodiment, the metal ion may no longer be bound to the organic ligand.

In another embodiment, a metal-organic solid of a proton exchange membrane can further comprise solvent molecules. Examples of solvents can include water, acetone, methanol, ethanol, isopropanol, tetrahydrofuran, hexane, toluene, ether, chloroform, methylene chloride, pentane, n-propanol, hexanes, N,N-dimethylformamide, N,N-diethylformamide, dimethylsulfoxide, ethyl acetate, methyl acetate and pyridine.

Metal-organic solids, such as those described above, can have many structural characteristics which function to provide proton exchange membranes which are more easily characterized than their polymer counterparts. For example, metal-organic solids can contain pores. These pores can be measured by X-ray crystallography, due to the crystallinity of some metal-organic solids. The pores of metal-organic solids can range from about 3 to about 25 Å (e.g., about 3 to about 8 Å, about 5 to about 10 Å, about 7 to about 15 Å, about 6 to about 12 Å, about 8 to about 20 Å, about 10 to about 25 Å, and about 16 to about 24 Å). In some embodiments, the pores can be from about 7 to about 15 Å. These pores can be used as locations for dopants, polymers, and/or solvent molecules within a metal-organic solid.

As mentioned above, a metal-organic solid can be crystalline. This crystallinity provides a characterizable structural order to a metal-organic solid, as well as facilitating techniques for determining the location of the metal cation, organic anion, dopant, polymer, solvent molecules, and/or additional counter anions or counter cations within a proton-exchange membrane. The structural order of a metal-organic solid can be planar, depending on the metal cation and organic anion used. In other embodiments, a metal-organic solid can have a layered structure.

Beyond these structural features, proton exchange membranes which include a metal-organic solid can be capable of transferring protons over a wide range of temperatures. For example, a proton exchange membrane may be capable of functioning from about 25 to about 250° C. (e.g., about 25 to about 75° C., about 50 to about 100° C., about 75 to about 125° C., about 100 to about 150° C., about 125 to about 200° C., and about 150 to about 250° C.). This range is broader than that typically accepted for proton exchange membranes comprised primarily of polymeric materials, which have been known to stop functioning at temperatures above 100° C. In some embodiments, the proton exchange membrane of the present disclosure may be able to function at temperatures in excess of 150° C.

### Methods of Making Proton Exchange Membranes

Further provided herein are methods of making proton exchange membranes which comprise a metal-organic solid. In one embodiment, the compounds described above can be prepared by providing a compound having formula (VI) or (VII):

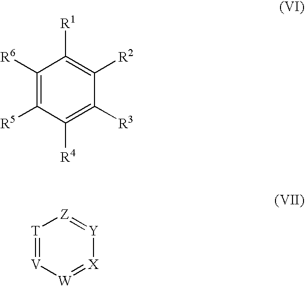

wherein Z is selected from CR¹, N, and NR¹⁵; Y is selected from CR², N, and NR16; X is selected from CR³, N, and NR¹⁷; W is selected from CR⁴, N, and NR¹⁸; V is selected from CR⁵, N, and NR¹⁹; T is selected from CR⁶, N, and NR²⁰; R¹, R², R³, R⁴, R⁵, and R⁶ are independently selected from H, OR⁷, NR⁷R⁸, SR⁷, CO₂H, (CH₂)ₙOR⁷, (CH₂)ₙNR⁷R⁸, (CH₂)ₙSR⁷, (CH₂)ₙCO₂H, and R⁹, or any two adjacent R groups come together to form a substituted or unsubstituted fused ring; R⁷ and R⁸ are independently H, C₁-C₁₀ alkyl, C₂-C₁₀ alkenyl, or C₂-C₁₀ alkynyl; R⁹ is a compound having the formula:

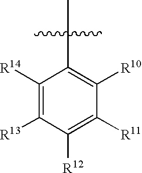

wherein R¹⁰, R¹¹, R¹², R¹³, and R¹⁴ are independently selected from H, OR⁷, NR⁷R⁸, SR⁷, CO₂H, (CH₂)ₙOR⁷, (CH₂)ₙNR⁷R⁸, (CH₂)ₙSR⁷, (CH₂)ₙCO₂H; n is an integer from 1 to 6; R¹⁵, R¹⁶, R¹⁷, R¹⁸, R¹⁹, and R²⁰ are independently selected from H, C₁-C₁₀ alkyl, C₂-C₁₀ alkenyl, or C₂-C₁₀ alkynyl; and wherein at least one of Z, Y, X, W, V, or T is N or the corresponding NR.

The compound of formula (VI) or (VII) can be reacted with a halogenated oxoacid. Examples of oxoacids can include halogenated: sulfuric acid, sulfurous acid, nitric acid, nitrous acid, phosphoric acid, phosphorous acid, hypophosphorous acid, selenic acid, selenous acid, chromic acid, chromous acid, arsenic acid, arsenous acid, hypoarsenous acid, periodic acid, iodic acid, iodous acid, perbromic acid, bromic acid, bromous acid, perchloric acid, chloric acid, and chlorous acid. For example, chlorinated sulfuric acid can be used in some embodiments.

The reaction product of a compound of formula (VI) or (VII) and a halogenated oxoacid can be reacted with a metal salt to provide a metal-organic solid. Examples of metal salts can include a metal: carbonate, halide, sulfate, phosphate, oxide, hydroxide, acetate, nitrate, tetrafluoroborate, hexafluorophosphate, organosulfonate, or organophosphonate.

The following non-limiting example illustrates a general reaction scheme which may be used in the production of a metal-organic solid as described herein.

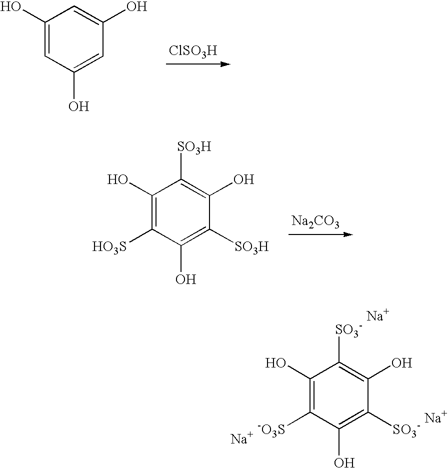

In further embodiments, prior to the addition of a metal salt, a dopant is added to the reaction product of a compound of formula (VI) or (VII) and a halogenated oxoacid. In certain embodiments, this dopant can include N-heterocycles and polymers comprising N-heterocycles. In other embodiments, a dopant can be added following the addition of the metal salt. For example, when an oxoacid is used as a dopant. In addition, oxo acids may be formed within the pores of a metal-organic solid via in situ hydrolysis (e.g., through the addition of NO₂ gas to H₂O filled channels to form HNO₃).

In another embodiment, a conjugate acid/base pair (or salt) can be formed between a dopant and the compound of formula (VI) or (VII). This dopant may be as described above and may be monomeric, oligomeric, or polymeric (e.g., polybenzimidazolium). The reaction product of a compound of formula (VI) or (VII) and a dopant can be further reacted with a metal salt to precipitate the desired material. In certain embodiments, this procedure can be expanded through digestion of the components in water within a hydrothermal autoclave.

### Methods of Using Proton Exchange Membranes

Proton exchange membranes can be used to transfer protons (or other ions, e.g., Li⁺) from an anode to a cathode within a fuel cell. For example, a fuel cell can be prepared comprising a proton exchange membrane which includes a metal-organic solid, as described above. The proton exchange membrane can be located in any position within a fuel cell as long as it can perform the function of transferring protons from an anode to a cathode. The method of transferring protons can be augmented through the addition of a dopant, for example, an N-heterocycle and/or an oxoacid. Measurements of proton transfer can be measured by any means known in the art, for example, through proton conduction experiments (e.g., using impedance spectroscopy).

In some embodiments, the relative humidity of the fuel cell is kept under 80% relative humidity (e.g., under 75%, under 70%, under 65%, under 60%, under 55%, under 50%, under 45%, under 40%, under 35%, under 30%, under 20%, under 10%). In other embodiments, the relative humidity of the fuel cell is kept under 50% relative humidity.

### DEFINITIONS

Unless defined otherwise, all technical and scientific terms used herein have the same meaning as is commonly understood by one of ordinary skill in the art to which this invention belongs. All patents, applications, published applications, and other publications are incorporated by reference in their entirety. In the event that there is a plurality of definitions for a term herein, those in this section prevail unless stated otherwise.

As used herein, “alkyl,” “alkenyl” and “alkynyl” carbon chains, if not specified, contain from 1 to 20 carbons, or 1 to 10 carbons, or 1 or 2 to 6 carbons, and are substituted or unsubstituted, straight or branched. Alkenyl carbon chains of from 1 to 10 carbons, in certain embodiments, contain 1 to 8 double bonds and alkenyl carbon chains of 2 to 10 carbons, in certain embodiments, contain 1 to 3 double bonds. Alkynyl carbon chains of from 2 to 10 carbons, in certain embodiments, contain 1 to 3 triple bonds, and the alkynyl carbon chains of 2 to 8 carbons, in certain embodiments, contain 1 to 3 triple bonds. Exemplary alkyl, alkenyl and alkynyl groups herein include, but are not limited to, methyl, ethyl, propyl, isopropyl, isobutyl, n-butyl, sec-butyl, tert-butyl, isopentyl, neopentyl, tert-pentyl, isohexyl, allyl (propenyl) and propargyl (propynyl).

As used herein, “aryl” refers to aromatic monocyclic or multicyclic groups containing from 6 to 19 carbon atoms. Aryl groups include, but are not limited to groups such as unsubstituted or substituted phenyl, and unsubstituted or substituted naphthyl.

As used herein, “substituted” refers to substitution by one or more substituents, in certain embodiments one, two, three, or four substituents, where non-limiting examples of the substituents include halo, pseudohalo, hydroxy, amino, thio, nitro, sulfono, phosphono, carboxy, alkyl, haloalkyl, aminoalkyl, diaminoalkyl, alkenyl containing 1 to 2 double bonds, alkynyl containing 1 to 2 triple bonds, cycloalkyl, aryl, heteroaryl, aralkyl, aralkenyl, aralkynyl, and alkoxy.

As used herein, “fused ring” refers to any ring containing 5 to 20 carbon atoms attached to the aryl ring of formula (I), (III), (V) or (VI). The ring may be substituted or unsubstituted, saturated or unsaturated. The ring may be a mono- or multicyclic ring systems. Non-limiting examples of fused rings include aryl, naphthyl, cyclohexyl, and cyclopentyl.

As used herein, “proton exchange membrane” refers to a membrane capable of conducting protons while being electrically insulating. The membrane should also be impermeable to fuels, for example, oxygen, hydrogen, and methane. Furthermore, a proton exchange membrane should not swell.

As used herein, an “acidic proton” refers to a moiety which may be protonated or unprotonated, depending on whether or not the moiety is involved in metal binding and/or the conditions under which the compound is used (e.g., pH of an aqueous solution). Furthermore, if more than one moiety within a compound contains an acidic proton, the moieties may exist independently as a mixture of protonated and unprotonated states, for example, PO₃H₂ and PO₃H⁻ may both be present on the same molecule.

### EXAMPLES

### Example 1

### Synthesis of Na₃PGS (Sodium 2,4,6-trihydroxybenzene-1,3,5-trisulfonate) (1)

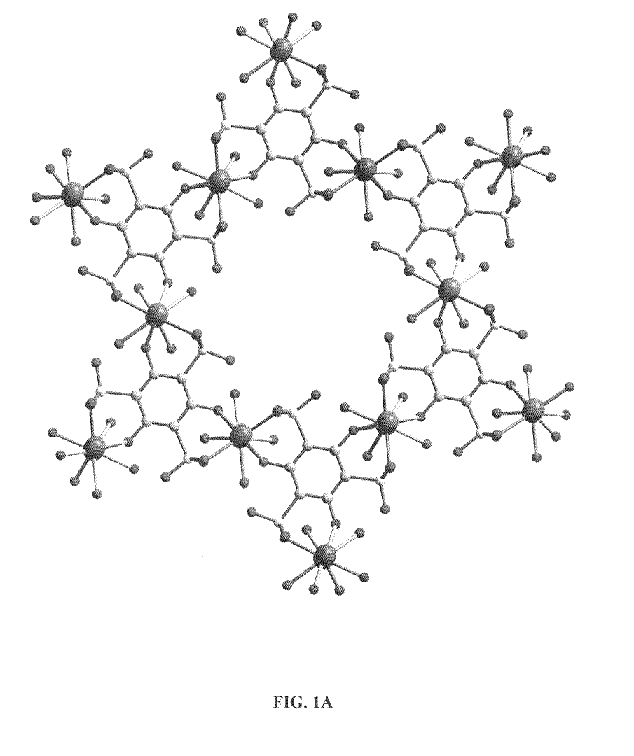

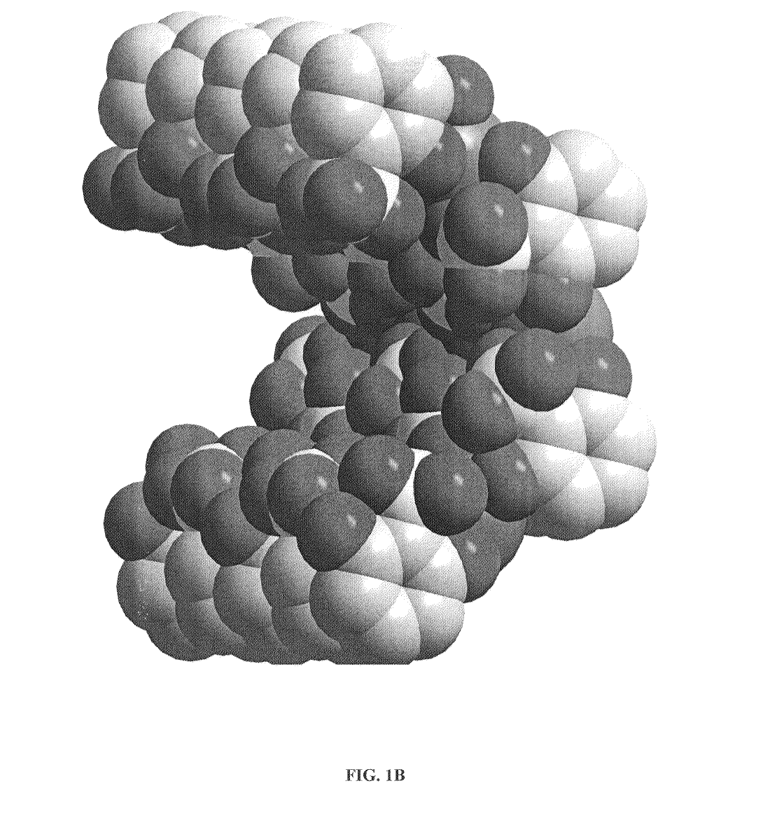

Anhydrous phloroglucinol (8.0534 g, 63.9 mmol) was dissolved in dry dimethyl carbonate (150 mL) and the resulting yellow solution cooled to 0° C. under Ar. Chlorosulfonic acid (12.76 mL, 191.6 mmol, 3.0 equiv.) was added dropwise over the course of 2 minutes with vigorous stirring, resulting in an orange colored solution. The reaction was warmed to ambient temperature and allowed to proceed for 1.5 h under a steady flow of Ar before the system was sealed and stirred for an additional 22.5 h. The solvent was then removed via rotary evaporation and the resulting viscous, brown oil dissolved in 150 mL of water. Sodium bicarbonate was added to the solution until it reached a pH of 3.0. Addition of the aqueous solution to 4 L of acetone resulted in the formation of a thick white precipitate, which was isolated via vacuum filtration. Compound (1) was characterized using NMR, X-ray crystallography (FIG. 1A-C), X-ray powder diffraction, thermogravimetric analysis (TGA)/differential scanning calorimetry (DSC) and variable temperature impedance spectroscopy.

### Example 2

### Synthesis of Na₃PGS-Imidazole (2)

Anhydrous phloroglucinol (8.2435 g, 65.4 mmol) was dissolved in dry dimethyl carbonate (150 mL) and the resulting yellow solution cooled to 0° C. under Ar. Chlorosulfonic acid (13.06 mL, 196.1 mmol, 3.0 equiv.) was added dropwise over the course of 2 minutes with vigorous stirring, resulting in an orange colored solution. The reaction was warmed to ambient temperature and allowed to proceed for 1.5 h under a steady flow of Ar before the system was sealed and stirred for an additional 22.5 h. The solvent was then removed via rotary evaporation and the resulting viscous, brown oil dissolved in 150 mL of water. Imidazole (4.4502 g, 65.4 mmol, 1.0 equiv.) was added to the aqueous solution and stirred for 24 h. Sodium bicarbonate was added to the solution until it reached a pH of 3.0. Addition of the aqueous solution to 4 L of acetone resulted in the formation of a thick white precipitate, which was isolated via vacuum filtration. Compound (2) was characterized using NMR, X-ray powder diffraction, TGA/DSC, and variable temperature impedance spectroscopy.

### Example 3

### Synthesis of Na₃PGS-(1,2,4-Triazole) (3)

Anhydrous phloroglucinol (8.2435 g, 65.4 mmol) was dissolved in dry dimethyl carbonate (150 mL) and the resulting yellow solution cooled to 0° C. under Ar. Chlorosulfonic acid (13.06 mL, 196.1 mmol, 3.0 equiv.) was added dropwise over the course of 2 minutes with vigorous stirring, resulting in an orange colored solution. The reaction was warmed to ambient temperature and allowed to proceed for 1.5 h under a steady flow of Ar before the system was sealed and stirred for an additional 22.5 h. The solvent was then removed via rotary evaporation and the resulting viscous, brown oil dissolved in 150 mL of water. 1,2,4-Triazole (1.0 equiv.) was added to the aqueous solution and stirred for 24 h. Sodium bicarbonate was added to the solution until it reached a pH of 3.0. Addition of the aqueous solution to 4 L of acetone resulted in the formation of a thick white precipitate, which was isolated via vacuum filtration. Compound (3) was characterized using NMR, X-ray powder diffraction, TGA/DSC, and variable temperature impedance spectroscopy.

### Example 4

### Synthesis of Na₃PGS-Pyrazole (4)

Anhydrous phloroglucinol (8.2435 g, 65.4 mmol) was dissolved in dry dimethyl carbonate (150 mL) and the resulting yellow solution cooled to 0° C. under Ar. Chlorosulfonic acid (13.06 mL, 196.1 mmol, 3.0 equiv.) was added dropwise over the course of 2 minutes with vigorous stirring, resulting in an orange colored solution. The reaction was warmed to ambient temperature and allowed to proceed for 1.5 h under a steady flow of Ar before the system was sealed and stirred for an additional 22.5 h. The solvent was then removed via rotary evaporation and the resulting viscous, brown oil dissolved in 150 mL of water. Pyrazole (1.0 equiv.) was added to the aqueous solution and stirred for 24 h. Sodium bicarbonate was added to the solution until it reached a pH of 3.0. Addition of the aqueous solution to 4 L of acetone resulted in the formation of a thick white precipitate, which was isolated via vacuum filtration. Compound (4) was characterized using NMR, X-ray powder diffraction, TGA/DSC, and variable temperature impedance spectroscopy.

### Example 5

### Synthesis of Cs₃PGS (5)

As in the preparation of (1), except Cs₂CO₃ replaced NaHCO₃ as the metal salt employed in the synthesis. Compound (5) was characterized using X-ray powder diffraction, TGA/DSC, and variable temperature impedance spectroscopy.

### Example 6

### Synthesis of Cs₃PGS-1,2,4-triazole (6)

As in the preparation of (3), except Cs₂CO₃ replaced NaHCO₃ as the metal salt employed in the synthesis. NMR, X-ray powder diffraction, TGA/DSC.

### Example 7

### Synthesis of Ca/SrPGS (7) and (8)

As in the preparation of (1), except either Ca(OH)₂ or Sr(OH)₂ replaced NaHCO₃ as the metal salt employed in the synthesis. In addition, unlike during the preparation of (1), the CaPGS (7) and SrPGS (8) products began to precipitate out of the aqueous solution prior to the addition of acetone. Compounds (7) and (8) were characterized using X-ray powder diffraction, TGA/DSC, and variable temperature impedance spectroscopy.

### Example 8

### Synthesis of BaPGS (9)

Na₃PGS (815.4 mg, 1.71 mmol) was dissolved in 35 mL of water. To this solution, BaCl₂ (626.0 mg, 2.56 mmol, 1.5 equiv.) was added resulting in the immediate formation of a thick, white precipitate. The solution was stirred for 12 h, before the white precipitate was isolated via vacuum filtration and washed with water (5 mL). Compound (9) was characterized using X-ray powder diffraction and TGA/DSC.

### Example 9

### Synthesis of α-NaPGS-SO₄ (10)

As in the preparation of (1), except Na₂SO₄ replaced NaHCO₃ as the metal salt employed in the synthesis. The resulting powder of compound (10) was characterized by X-ray powder diffraction, TGA/DSC, and elemental analysis.

### Example 10

### Synthesis of α-NaPGS-PO₄ (11)

As in the preparation of (1), except Na₃PO₄ replaced NaHCO₃ as the metal salt employed in the synthesis. Powder of compound (11) was characterized by X-ray powder diffraction, TGA/DSC, and elemental analysis.

### Example 11

### Synthesis of α-NaPGS-NO₃ (12)

As in the preparation of (1), except NaNO₃ replaced NaHCO₃ as the metal salt employed in the synthesis. The resulting powder of compound (12) was characterized by X-ray powder diffraction, TGA/DSC, and elemental analysis.

### Example 12

### Synthesis of α-NaPGS-H₂SO₄ composite (13)

To a vial containing NaPGS (0.3847 g, 0.890 mmol) was added 1 mL of a 2 M H₂SO₄ solution. The water was allowed to evaporate leaving a gummy yellow powder. The powder of compound (13) was characterized by X-ray powder diffraction and TGA/DSC.

### Example 13

### Synthesis of α-NaPGS-HNO₃ composite (14)

To a vial containing NaPGS (0.3843 g, 0.889 mmol) was added 1 mL of a 2 M HNO₃ solution. The water was allowed to evaporate leaving a gummy red powder. The resulting powder of compound (14) was characterized by X-ray powder diffraction and TGA/DSC.

### Example 14

### Synthesis of β-NaPGS-(1,2,4-Triazole) (15)

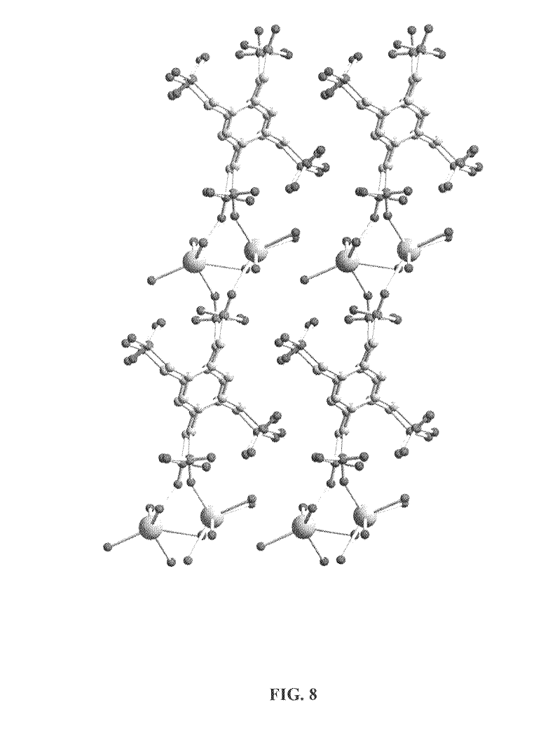

Approximately 2 g of as synthesized α-NaPGS-(1,2,4-Triazole) (3) was packed into a silicone tube and sealed. The sealed tube was pressed under a hydrostatic pressure of 20,000 lbs for 10 min. The resulting pellet was then removed from the silicone tube and left at ambient conditions for several months. Powder of compound (15) was characterized by NMR, FT-IR, powder X-ray diffraction (FIG. 8), thermogravimetric analysis, elemental analysis and DSC, scanning electron microscopy and energy dispersive analysis of X-rays. Detailed impedance analysis has been performed. [George: Please confirm that this is the correct compound. You had previously named it NaPGS-Tz.]

### Example 15

### Synthesis of DHP (2,5-Dihydroxy-1,4-phenylenediphosphonic acid) (16)

To a mixture of hydroquinone (22 g, 0.2 mol), carbon tetrachloride (180 mL), and diethyl phosphite (53.6 ml, 0.416 mol) cooled to 0° C., was added triethylamine (57.2 ml, 0.416 mol) dropwise. The mixture was stirred overnight at room temperature, water (200 mL) was added, and the organic layer was separated and dried over anhydrous Na₂SO₄. Removal of solvent on a rotary evaporator left tetraethyl 1,4-phenylene bis(phosphate) (PBP) as a colorless liquid.

To a solution of diisopropylamine (22.4 g, 0.22 mol) in THF (100 mL) at −78° C. under nitrogen was added n-butyllithium (136.6 ml, 1.6 M in hexane, 0.217 mol). The mixture was stirred for 30 min and PBP (19 g, 0.05 mol) dissolved in 100 mL THF was then added with a syringe. The mixture was stirred at −78° C. for 1 h. The dry ice-acetone bath was then removed and the mixture was allowed to stir for an additional 1 h. It was next poured over a mixture of a saturated solution of ammonium chloride (150 mL) and ether (200 mL). The ether layer was separated and the aqueous layer was extracted with methylene chloride. The combined organic extracts were dried over anhydrous Na₂SO₄. Removal of solvent on a rotary evaporator gave tetraethyl (2,5-dihydroxy-1,4-phenylene)bis(phosphonate) (DHPE) as a pinkish solid which was purified by recrystallization from methylene chloride/petroleum ether.

A mixture of DHPE (5 g), 18% HCl (50 mL), and dioxane (50 mL) was refluxed for 16 h. The solvents were removed on a rotary evaporator and the residue was refluxed with 18% HCl (50 mL) for 2 h. Removal of water and HCl on a rotary evaporator gave a syrup which solidified on trituration with acetonitrile. The solid (DHP) was collected by filtration and crystallized from water-acetonitrile to yield colorless, long needles. Compound (10) was characterized using mass spectrometry (MS), NMR, IR, and elemental analysis

### Example 16

### Synthesis of DDHP(3,3-Dihydroxy-4,4-biphenol bis(phosphoric acid) (17)

As in the preparation of (1), except 4,4-biphenol was used in place of hydroquinone. Compound (17) was characterized using MS, NMR, IR, and elemental analysis.

### Example 17

### Synthesis of ZnDHP (18)

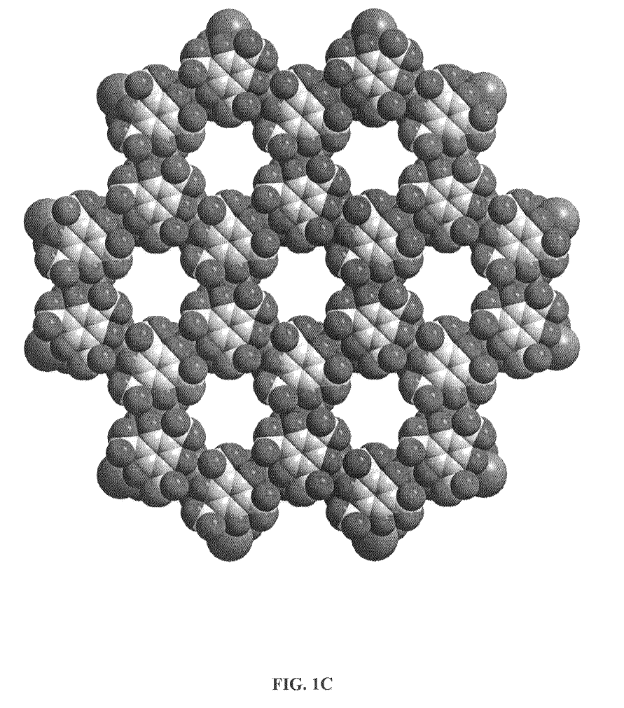

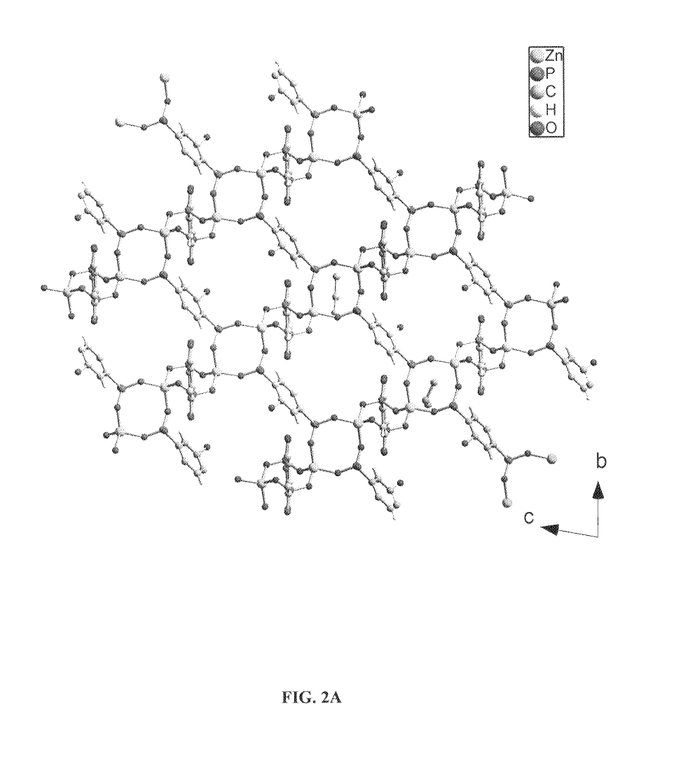

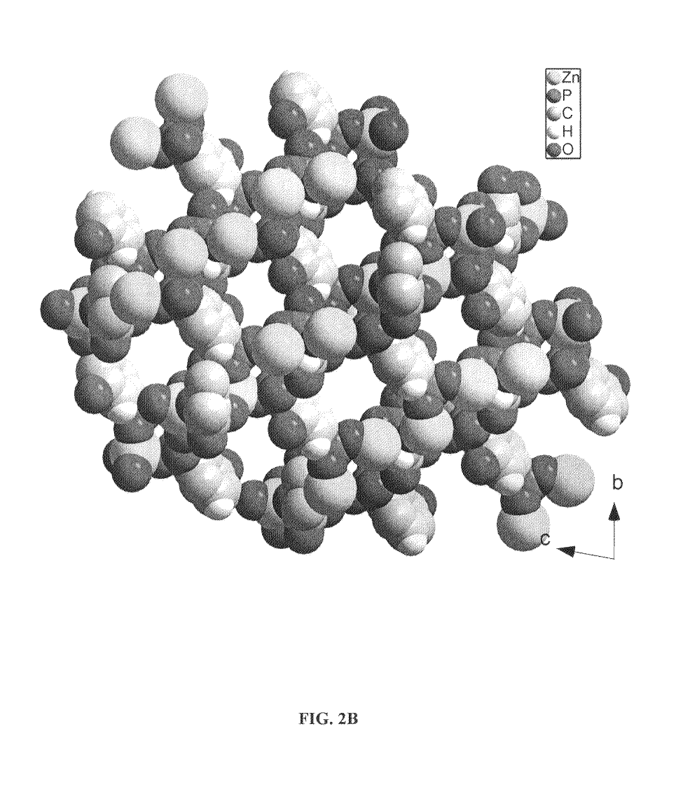

DHP (81 mg, 0.3 mmol) was dissolved in 5 mL of water. To this solution, ZnCO₃×2 Zn(OH)₂ (324 mg, 0.1 mmol) was added, resulting in the immediate formation of a white precipitate and bubbling. The precipitate was filtered. HCl (1 M) was added dropwise to the precipitate with stirring until the precipitate went into solution. This solution was then diffused by pyridine in methanol (5 mol %). After 3 days, colorless rectangular crystals were collected. Compound (18) was characterized using MS, NMR, IR, X-ray crystallography (FIG. 2A-B), and elemental analysis.

### Example 18

### Synthesis of CaDHP (19)

DHP (108 mg, 0.4 mmol) was dissolved in 5 ml of water. To this solution, CaCO₃ (40 mg, 0 4 mmol) was added resulting in a cloudy solution with CO₂ evolution. Several drops of HCl (1 M) were added to the solution to make it clear. Triethylamine was diffused into a methanol solution (5 mol %) of this solid which resulted in colorless crystals in one day. Compound (19) was characterized using X-ray powder diffraction, X-ray crystallography (FIG. 3), and TGA/DSC.

### Example 19

### Synthesis of H₈TMPB (benzene-1,2,4,5-tetrayltetrakis(methylene)tetraphosphonic acid) (20)

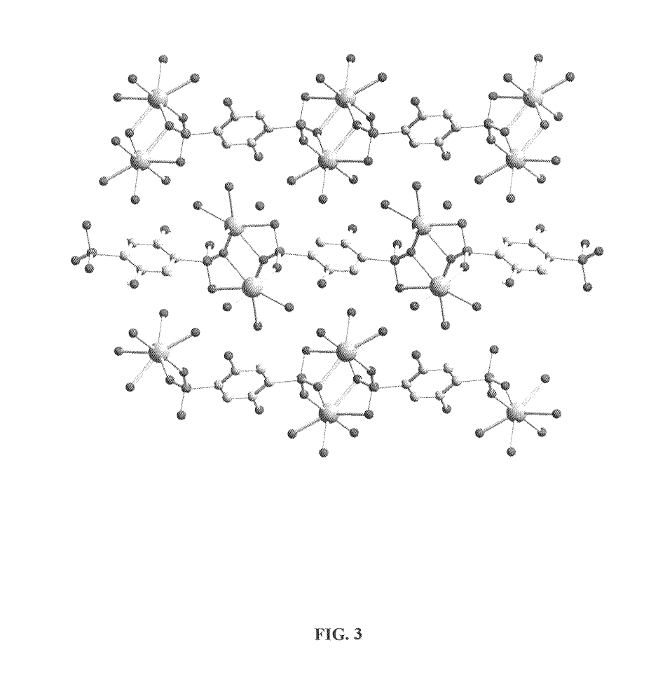

1,2,4,5-Tetrakis(bromomethyl)benzene (6.958 g, 0.0155 mol) and triethyl phosphite (58.14 g, 0.350 mol) were added to a round bottomed flask and refluxed under dry nitrogen for 36 hours. The excess triethyl phosphate was then removed by distillation under vacuum to obtain a brown viscous liquid. Concentrated aqueous hydrochloric acid (60 mL) was then added to the flask and refluxed for 12 hours, a yellow solid precipitated from solution during this time. The hydrochloric acid was then removed by rotary evaporation, and fresh water (300 mL) was then added to the yellow precipitate and heated until fully dissolved into a yellow solution, at which point the solution was decolorized with charcoal. The water in the remaining clear solution was then removed by rotary evaporation and the remaining white solid was dried under vacuum to yield 3.935 g of product (55.9% yield). The product was characterized by NMR, IR, elemental analysis, and single-crystal X-ray analysis (FIG. 4).

### Example 20

### Synthesis of ZnTMPB (21)

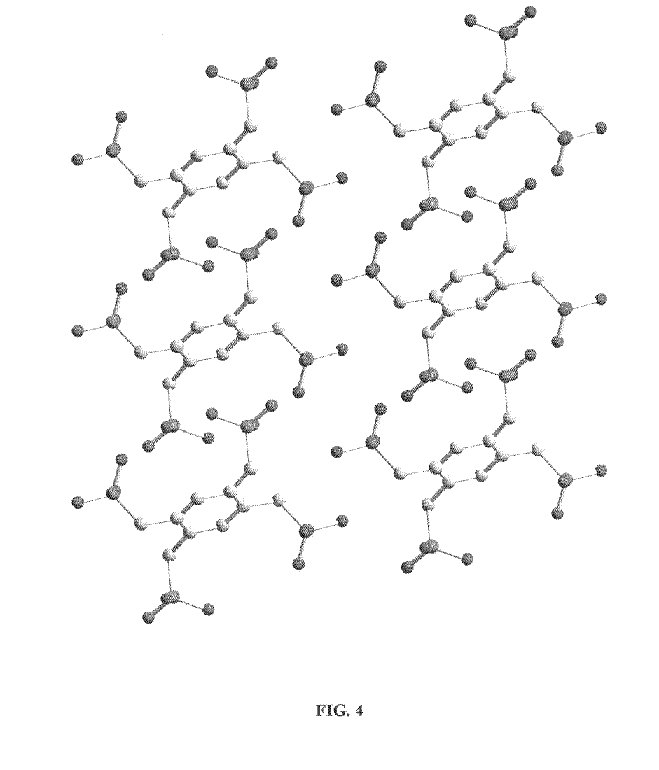

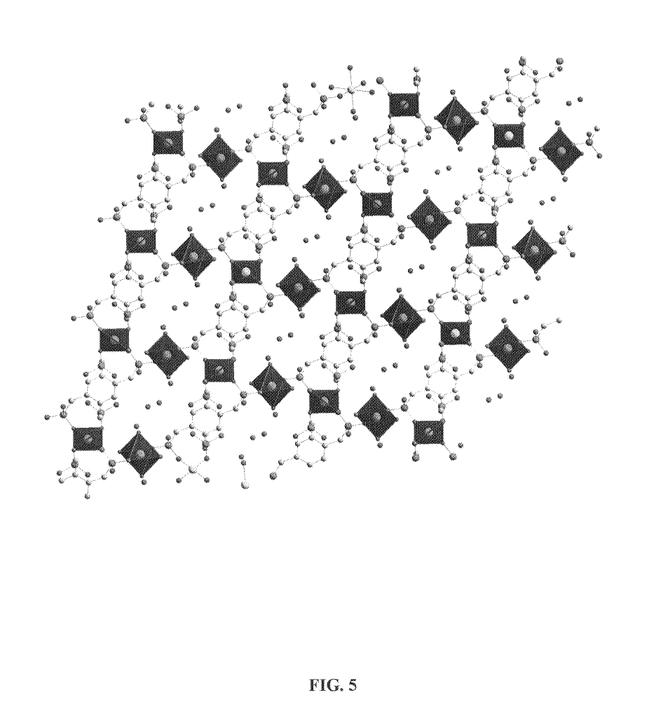

H₈TMPB (190 mg, 0.419 mmol) was dissolved in water (180 mL), and separately zinc perchlorate hexahydrate (470 mg, 1.27 mmol) was dissolved in water (20 mL). The solutions were subsequently mixed to form a clear colorless solution. Crystal growth occurred overnight and crystals were characterized by FT-IR, thermogravimetric analysis, DSC, elemental analysis, single crystal X-ray diffraction (FIG. 5), and PXRD.

### Example 21

### Synthesis of CaTMPB (22)

H₈TMPB (98 mg, 0.216 mmol) and CaCl₂ (4 mole equivalent) were dissolved in water (12 mL) to make a clear colorless solution. Slow diffusion of methanol or ethanol causes crystals to form over a week. Crystals characterized by FT-IR, single crystal X-ray diffraction (FIG. 6), thermogravimetric analysis, elemental analysis and DSC.

### Example 22

### Synthesis of SrTMPB (23)

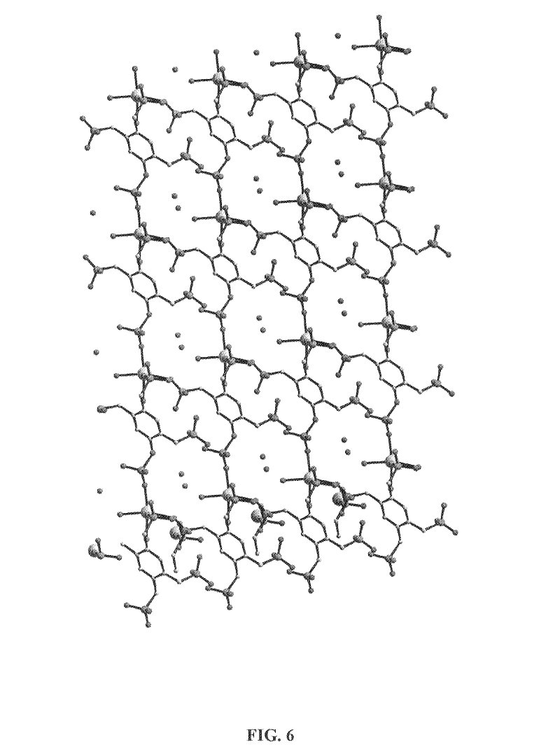

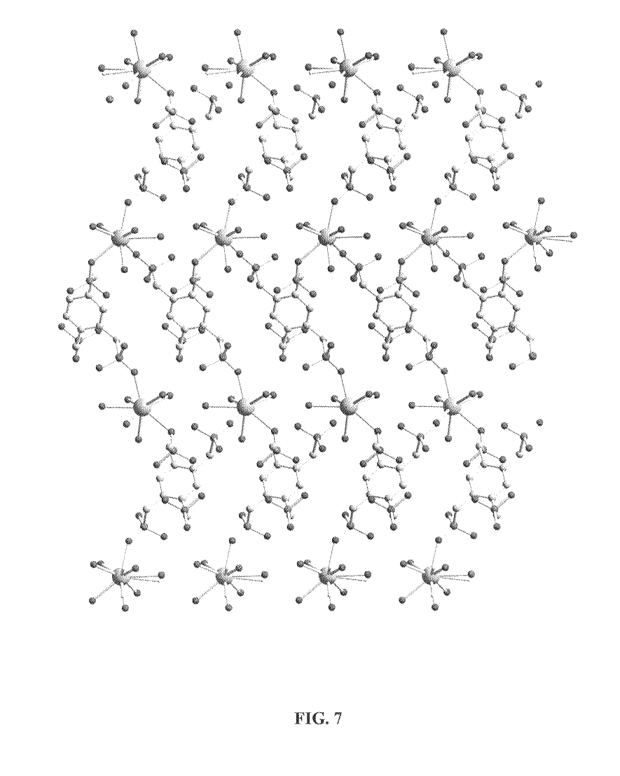

H₈TMPB (98 mg, 0.216 mmol) and SrCl₂ (4 mole equivalent) were dissolved in water (12 mL) to make a clear colorless solution. Slow diffusion of methanol or ethanol causes crystals to form over a week. Crystals characterized by FT-IR, single crystal X-ray diffraction (FIG. 7), thermogravimetric analysis, elemental analysis and DSC.

### Example 23

### Synthesis of BaTMPB (24)

H₈TMPB (168 mg, 0.370 mmol) and Ba(ClO₄)₂ (320 mg, 0.953 mmol) were dissolved in water (15 mL) to make a clear colorless solution. Slow diffusion of petroleum ether causes crystals to form over a week. Crystals characterized by FT-IR, single crystal X-ray diffraction (FIG. 8), thermogravimetric analysis, elemental analysis and DSC.

### Example 24

### Synthesis of EuTMPB (25)

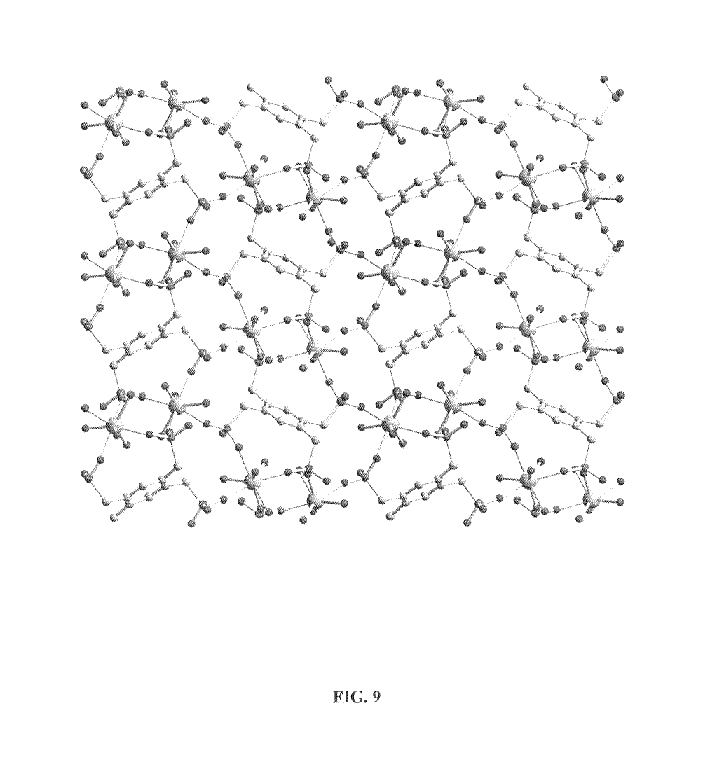

H₈TMPB (118 mg, 0.260 mmol) and europium chloride hexahydrate (77 mg, 0.210 mmol) were dissolved in water (22 mL) to make a cloudy white precipitate. He mixture was the acidified with aqueous hydrochloric acid (6 M) until the solution became clear. The solution was then placed over an acetone/pyridine mixture (60:1 by volume). A white crystalline powder forms after two days. Crystals characterized by FT-IR, single crystal X-ray diffraction (FIG. 9), thermogravimetric analysis, elemental analysis and DSC.

### Example 25

### Synthesis of Eu₂H₂TMPB.5H₂O (26)

H₈TMPB (118 mg, 0.260 mmol) and europium chloride hexahydrate (77 mg, 0.210 mmol) were dissolved in water (22 mL) to make a cloudy white precipitate. The mixture was then acidified with aqueous hydrochloric acid (6 M) until the solution became clear. The solution was then placed over an acetone/pyridine mixture (60:1 by volume). A white crystalline powder formed after two days. Crystals were characterized by FT-IR, single crystal x-ray diffraction, thermogravimetric analysis and DSC. PXRD of initial white precipitate matches simulated pattern from the single crystal x-ray diffraction.

### Example 26

### Synthesis of H₆MTPA (27)

1,3,5-Tris(bromomethyl)benzene (2.024 g, 5.721 mmol) and triethyl phosphite (19.38 g, 116.6 mmol) were added to a round bottom flask and refluxed under dry nitrogen for 36 hours. The excess triethyl phosphite was then removed by distillation under vacuum to obtain a brown viscous liquid. Concentrated aqueous hydrochloric acid (35 mL) was then added to the flask and refluxed for 12 hours, a brown solid precipitated from solution during this time. The hydrochloric acid was then removed by rotary evaporation, and fresh water (300 mL) was then added to the brown precipitate and heated until fully dissolved into a yellow-brown solution, at which point the solution was decolorized with charcoal (Norit A). The water in the remaining clear solution was then removed by rotary evaporation and the remaining white solid was dried under vacuum to yield 1.362 g of product (66.1% yield). The product was characterized by NMR. Synthesis outlined in New J. Chem., 2004, 28, 1244-1249.

### Example 27

### Synthesis of Metal MTPA Complexes

In a general procedure for room temperature crystallizations, H₆MTPA (0.050 g, 0.139 mmol) was dissolved in water (6 mL). Separately, one molar equivalent of a divalent metal perchlorate, (Zn(ClO₄)₂.6H₂O or Cu(ClO₄)₂.6H₂O), or an alkaline earth chloride hydrate (CaCl₂.2H₂O, SrCl₂.6H₂O) was dissolved in water (4 mL). The two solutions were mixed to form a clear colorless solution (clear blue in the case of Cu), and the solution was placed in an atmosphere of methanol or ethanol vapour. Crystalliztion occurs after one week.

For hydrothermal crystallizations, H₆MTPA (0.100 g, 0.278 mmol) and two molar equivalents of a divalent metal carbonate (M²⁺=Ca, Sr, Ba, Mn, Ni, Cu, Zn) were mixed with water (5 mL) in a teflon autoclave. The autoclave was subsequently heated from room temperature to 120° C. over 1 hour, temperature was then kept constant at 120° C. for 48 hours, and then the autoclave was cooled back to room temperature over 12 hours. Crystals recovered from the autoclave were tested by PXRD or single-crystal X-ray diffraction depending on the crystal size. PXRD was used to determine phase purity.

For LaH₃MTPA.5H₂O, H₆MTPA (0.0485 g, 0.135 mmol) was dissolved in water (10 mL), and separately, LaCl₃.6H₂O (0.0465 g, 0.132 mmol) was dissolved in water (10 mL), then the two solutions were mixed to form a clear colorless solution. Solution was left open in the air and after three days crystals formed in the solution.

### Example 28

### Synthesis of pyrene-1,3,6,8-tetraphosphonate octaethylester (28)

1,3,6,8-tetrabromopyrene (2.023 g, 3.907 mmol) was added to meta-diisopropyl benzene (50 mL) in a 3-necked round bottomed flask fitted with a dropping funnel, a nitrogen inlet and a reflux condenser. Anhydrous NiBr₂ (508 mg) was then added to the solution and the mixture was placed under a dry N₂ atmosphere. In the dropping funnel, triethyl phosphite (3.876 g, 23.3 mmol) was mixed with diisopropyl benzene (20 mL). The flask was then heated to reflux and the triethyl phosphite mixture was slowly added dropwise over three hours. Reflux was continued for 36 hours, and then the flask was cooled to ˜50° C. and filtered to remove NiBr₂, leaving a clear brown filtrate. The diisopropyl benzene was then reduced to 10 mL and a dark brown precipitate formed upon cooling. The precipitate was recovered by filtration and washed with copious amounts of diethyl ether to remove remaining solvent and phosphite. 1.816 g brown crystalline product recovered (62.2% yield). ¹H-NMR (200 MHz, CDCl₃), 9.28 (t, 2H), 9.19 (s, 4H), 4.28 (q, 16H), 1.39 (t, 24H).

### Example 29

### Synthesis of pyrene-1,3,6,8-tetraphosphonic acid (TPP) (29)

Pyrene-1,3,6,8-tetraphosphonate octaethylester (1.816 g, 2.432 mmol) was refluxed in concentrated aqueous HCl (25 mL) for 8 hours. After reflux a yellow-white precipitate had formed. The solution was cooled to room temperature, filtered and washed with cold water (10 mL) to obtain pyrene-1,3,6,8-tetraphosphonic acid in quantitative yield. ¹H-NMR (200 MHz, CDCl₃), 9.28 (t, 2H), 9.19 (s, 4H).

### Example 30

### Synthesis of Metal pyrene-1,3,6,8-tetraphosphonic Acid Complexes

In a general procedure, pyrene-1,3,6,8-tetraphosphonic acid (0.100 g, 0.192 mmol) and two molar equivalents of a divalent metal carbonate were added to a teflon autoclave. The autoclave was subsequently heated from room temperature to 100° C. over 1 hour, temperature was then kept constant at 100° C. for 48 hours, and then the autoclave was cooled back to room temperature over 12 hours. Crystals recovered from the autoclave were tested by PXRD or single-crystal X-ray diffraction depending on the crystal size. PXRD was used to determine phase purity.

### Example 31

### Synthesis of Trisodium Tri(m-Sulfonatophenyl)Phosphine (NaTPPS) (30)

The trisodium tri(m-Sulfonatedphenyl)phosphine, Na₉(P(C₆H₄SO₃)₃)₃(P(C₆H₄SO₃H)₃)(H₂O)₁₀, (30) was synthesized using a reported procedure (S. Hida, P. J. Roman Jr., A. A. Bowden, J. D. Atwood, J. Coord. Chem. (1998), 43, 345-348). NaTPPS was then recrystallized from water by slow evaporation to obtain single crystals. The structure was solved using single crystal x-ray diffraction analysis. The bulk purity was established from powder x-ray diffraction studies.

### Example 32

### Synthesis of NaTPPS-Tz (31)

About 0.5 g of (30) was dissolved in an 8 mL water and 5 mL methanol mixture and treated with 3 mole equivalents of 1,2,4-triazole. The clear solution obtained was allowed to stand at 25° C. for a week to obtain a white crystalline solid, which was filtered and washed with methanol to remove any excess triazole.

### Example 33

### Electrical Characterization—Method I

Samples for electrical characterization were prepared by first grinding the as synthesized solids into homogeneous powders with a mortar and pestle. The powders were then pressed into cylindrical pellets using hydrostatic pressure (9 tonnes, 10 minutes), cut into thin samples (2-3 mm thickness) using a jewelry saw and the surfaces polished with 600 grit sand paper. Electrical conductivity measurements were performed on the pellets employing a Solartron SI 1260 impedance and gain-phase analyzer (100 Hz-20 MHz). A two-probe cell, with platinum sheet electrodes and either an ambient or hydrogen atmosphere. The effect of temperature on conductivity was also probed by heating the samples in a Barnstead-Thermolyne 21100 tube furnace. The heated samples were equilibrated at each temperature for 1 h prior to a measurement.

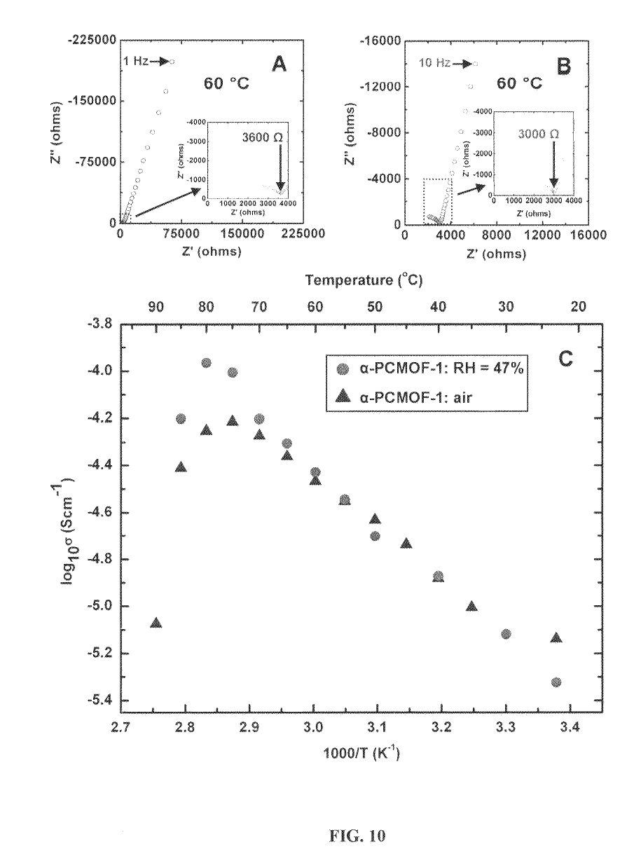

A representative plot of impedance data is shown in FIG. 10. Impedance analysis of as synthesized (1) (α-PCMOF-1) measured in air compared to a humidified N₂ atmosphere, RH=47%. (A) shows an impedance plot for (1) measured in air (1 MHz-1 Hz). (B) displays an impedance plot for (1) measured in N₂ at RH=47% (1 MHz-10 Hz). All plots for these materials possessed the same appearance, differing only in the position of the semicircle on the Z′ axis. (C) is an Arrhenius plot comparing the conductivity of (1) in air and a humidified N₂ atmosphere, RH=47%. At higher temperatures (T≧60° C.), the conductivity of the hydrated sample was better than that of the sample measured in air, suggesting that water functions as a mobile ion carrier for protons within the metal-organic solid.

TABLE 1
Impedance Data

| | | | | Proton |
|---|---|---|---|---|
| | Temperature | | | conductivity |
| Compound | (° C.) | | Atmosphere | (Scm⁻¹) |
| NaPGS | 20 | | Air | 7 × 10⁻⁷ |
| NaPGS | 73 | | Air | 9.29 × 10⁻⁴ |
| NaPGS | 61 | | Air | 3.88 × 10⁻⁴ |
| NaPGS | 26 | | Air | 1.73 × 10⁻⁴ |
| NaPGS•imidazole | 145 | | H₂ | 1.30 × 10⁻⁶ |
| NaPGS•1,2,4-triazole | 23 | | H₂ | 1.23 × 10⁻⁴ |
| NaPGS•1,2,4-triazole | 45 | | H₂ | 1.19 × 10⁻⁴ |
| NaPGS•1,2,4-triazole | 80 | | H₂ | 1.33 × 10⁻⁴ |
| NaPGS•1,2,4-triazole | 100 | | H₂ | 1.72 × 10⁻⁴ |
| NaPGS•1,2,4-triazole | 120 | | H₂ | 2.21 × 10⁻⁴ |
| NaPGS•1,2,4-triazole | 140 | | H₂ | 3.9 × 10⁻⁴ |
| NaPGS•1,2,4-triazole | 150 | | H₂ | 4.20 × 10⁻⁴ |
| CsPGS (hydrated 16 hrs) | 22 | | Air | 2.90 × 10⁻³ |
| CsPGS (hydrated 16 hrs) | 38 | (30 min) | Air | 2.33 × 10⁻⁴ |
| CsPGS (hydrated 16 hrs) | 38 | (40 min) | Air | 2.04 × 10⁻⁴ |
| CsPGS (hydrated 16 hrs) | 38 | (60 min) | Air | 6.26 × 10⁻⁵ |
| CsPGS (hydrated 19 hrs) | 22 | (0 min) | Air | 5.81 × 10⁻³ |
| CsPGS (hydrated 19 hrs) | 22 | (90 min) | Air | 5.43 × 10⁻⁴ |
| CsPGS (hydrated 19 hrs) | 22 | (180 min) | Air | 1.63 × 10⁻⁴ |
| CsPGS (hydrated 19 hrs) | 22 | (240 min) | Air | 1.02 × 10⁻⁴ |
| CsPGS (hydrated 19 hrs) | 22 | (540 min) | Air | 2.04 × 10⁻⁵ |

| | | | |
|---|---|---|---|
| CsPGS (hydrated 14 hrs) | 23 | Air | 1.64 × 10⁻³ |
| CsPGS (hydrated 14 hrs) | 30 | Air | 3.72 × 10⁻³ |
| CsPGS (hydrated 14 hrs) | 75 | Air | 1.37 × 10⁻⁴ |
| CsPGS (hydrated 14 hrs) | 80 | Air | 1.81 × 10⁻⁵ |
| CaTMPB | 22 | Air | 2.6 × 10⁻⁵ |
| CaTMPB | 34 | Air | 5.3 × 10⁻⁶ |
| CaTMPB | 52 | Air | 1.2 × 10⁻⁶ |
| CaTMPB | 70 | Air | 2.3 × 10⁻⁸ |
| CaTMPB | 75 | Air | 5.7 × 10⁻⁹ |

### Example 34

### Conductivity of (30) from Impedance Analysis

Compound (30) (no external hydration) conducts from 25 to 100° C. and above this temperature the conductivity drops down to negligible values. The highest conductivity was observed at 90° C. (˜9×10⁻⁴ S cm⁻²). Compound (31) shows conductivity even at 180° C. (˜4×10⁻⁴ S cm⁻²), although above this temperature the structure seems to collapse.

### Example 35

### Electrical Characterization—Method II

Impedance analysis was performed on the as synthesized powders without any modification. All pellets were prepared by first grinding the samples into a homogeneous powder with a mortar and pestle. Afterwards, the powders (˜0.3 g) were added to a standard 13 mm die, sandwiched between two porous carbon electrodes (Sigracet, GDL 10 BB, 1.222 cm diameter) and pressed at 10,000 lbs for 2 minutes.

All pellets were 13 mm in diameter and ranged in thickness from 0.147 to 0.118 cm. Measurements were performed using an impedance and gain-phase analyzer (SI model 1260) (1 Hz-1 MHz), with a two-probe electrochemical cell equipped with platinum current collectors and an applied AC voltage of 10 mV (unless otherwise stated). Measurements were taken in the temperature range of 23 to 150° C. and either in air or an anhydrous hydrogen atmosphere.

TABLE 2
Impedance data for NAPGS-SO₄ (10) under air.

| Temperature (° C.) | Conductivity (Scm⁻¹) |
|---|---|
| 23 | 1.96 × 10⁻⁰⁷ |
| 35 | 4.07 × 10⁻⁰⁷ |
| 55 | 2.10 × 10⁻⁰⁶ |
| 70 | 7.13 × 10⁻⁰⁶ |
| 90 | 1.82 × 10⁻⁰⁵ |
| 110 | 2.96 × 10⁻⁰⁵ |
| 120 | 3.79 × 10⁻⁰⁵ |
| 130 | 4.77 × 10⁻⁰⁵ |
| 140 | 5.49 × 10⁻⁰⁵ |
| 150 | 7.46 × 10⁻⁰⁵ |

TABLE 3
Impedance data for NAPGS-PO₄ (11) under air.

| Temperature (° C.) | Conductivity (Scm⁻¹) |
|---|---|
| 23 | 2.83 × 10⁻⁰⁷ |
| 35 | 5.36 × 10⁻⁰⁷ |
| 55 | 5.00 × 10⁻⁰⁶ |
| 70 | 9.53 × 10⁻⁰⁶ |
| 90 | 1.49 × 10⁻⁰⁵ |
| 110 | 1.13 × 10⁻⁰⁵ |
| 120 | 8.55 × 10⁻⁰⁶ |
| 130 | 5.75 × 10⁻⁰⁶ |
| 140 | 4.38 × 10⁻⁰⁶ |

TABLE 4
Impedance data for CsPGS-Tz (6) under hydrogen atmosphere.

| Temperature (° C.) | Conductivity (Scm⁻¹) |
|---|---|
| 23 | 5.53 × 10⁻⁰⁹ |
| 30 | 1.13 × 10⁻⁰⁸ |
| 40 | 3.81 × 10⁻⁰⁸ |
| 50 | 9.24 × 10⁻⁰⁸ |
| 60 | 9.82 × 10⁻⁰⁸ |
| 70 | 1.29 × 10⁻⁰⁷ |
| 80 | 2.83 × 10⁻⁰⁷ |
| 90 | 5.62 × 10⁻⁰⁷ |
| 100 | 3.96 × 10⁻⁰⁷ |
| 110 | 2.79 × 10⁻⁰⁷ |
| 120 | 4.93 × 10⁻⁰⁶ |
| 130 | 2.47 × 10⁻⁰⁵ |
| 140 | 1.43 × 10⁻⁰⁴ |
| 150 | 2.47 × 10⁻⁰³ |
| 150 (24 h) | 2.78 × 10⁻⁰³ |
| 150 (48 h) | 2.36 × 10⁻⁰³ |
| 150 (72 h) | 2.13 × 10⁻⁰³ |

TABLE 5
Impedance data for NaPGS-NO₃ (12) under air.

| Temperature (° C.) | Conductivity (Scm⁻¹) |
|---|---|
| 23 | 6.96 × 10⁻⁰⁷ |
| 65 | 5.34 × 10⁻⁰⁶ |
| 85 | 2.38 × 10⁻⁰⁵ |
| 105 | 5.32 × 10⁻⁰⁵ |
| 120 | 6.21 × 10⁻⁰⁵ |
| 135 | 4.91 × 10⁻⁰⁵ |
| 145 | 3.36 × 10⁻⁰⁵ |

TABLE 6
Impedance data for NaPGS-HNO₃ composite (14) under air:

| Temperature (° C.) | Conductivity (Scm⁻¹) |
|---|---|
| 23 | 1.99 × 10⁻⁰⁶ |
| 60 | 1.83 × 10⁻⁰⁵ |
| 90 | 5.44 × 10⁻⁰⁵ |
| 105 | 4.01 × 10⁻⁰⁵ |
| 120 | 3.20 × 10⁻⁰⁵ |
| 135 | 6.29 × 10⁻⁰⁵ |
| 145 | 2.24 × 10⁻⁰⁵ |
| 155 | 3.88 × 10⁻⁰⁶ |

A number of embodiments of the invention have been described. Nevertheless, it will be understood that various modifications may be made without departing from the spirit and scope of the invention. Accordingly, other embodiments are within the scope of the following claims.

What is claimed is:

1. A proton exchange membrane comprising a metal-organic solid comprising a salt of:
1) a metal cation and
2) a compound having the formula: 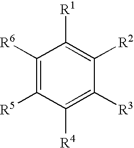
wherein:
R¹, R², R³, R⁴, R⁵, and R⁶ are independently selected from H, OR⁷, NR⁷R⁸, SR⁷, CO₂H, SO₃H, PO₃H₂, PR⁷R⁸, (CH₂)ₙOR⁷, (CH₂)ₙNR⁷R⁸, (CH₂)ₙSR⁷, (CH₂)ₙCO₂H, (CH₂)ₙSO₃H, (CH₂)ₙPO₃H₂, and R⁹, or any two adjacent R groups come together to form a substituted or unsubstituted fused ring;
R⁷ and R⁸ are independently H, C₁-C₁₀ alkyl, C₂-C₁₀ alkenyl, C₂-C₁₀ alkynyl; or aryl;
R⁹ is a compound having the formula: 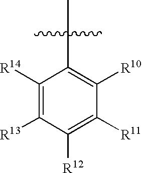
wherein:
R¹⁰, R¹¹, R¹², R¹³, and R¹⁴ are independently selected from H, OR⁷, NR⁷R⁸, SR⁷, CO₂H, SO₃H, PO₃H₂, (CH₂)ₙOR⁷, (CH₂)ₙNR⁷R⁸, (CH₂)ₙSR⁷, (CH₂)ₙCO₂H, (CH₂)ₙSO₃H, (CH₂)ₙPO₃H₂;
n is an integer from 1 to 6; and
wherein the compound comprises at least one acidic proton.

2. The proton exchange membrane of claim 1, wherein R¹-R⁶ are independently selected from H, OR⁷, SO₃H, and PO₃H₂.

3. The proton exchange membrane of claim 1, wherein the metal cation is one or more of the following:
Li⁺, Na⁺, K⁺, Rb⁺, Cs⁺, Mg²⁺, Ca²⁺, Sr⁺, Ba²⁺, Sc³⁺, Y³⁺, La³⁺, Ce⁴⁺, Ce³⁺, Pr³⁺, Nd³⁺, Sm³⁺, Eu³⁺, Gd³⁺, Tb³⁺, Dy³⁺, Ti⁴⁺, Ti³⁺, Zr⁴⁺, Hf⁴⁺, V⁴⁺, V³⁺, V²⁺, Nb³⁺, Ta³⁺, Cr³⁺, Mo³⁺, Mo²⁺, W³⁺, Mn³⁺, Mn²⁺, Re³⁺, Re²⁺, Fe⁴⁺, Fe³⁺, Fe²⁺, Ru³⁺, Ru²⁺, Os³⁺, Os²⁺, Co³⁺, Co²⁺, Rh³⁺, Rh²⁺, Rh⁺, Ir³⁺, Ir²⁺, Ir⁺, Ni²⁺, Ni⁺, Pd²⁺, Pd⁴⁺, Pd⁺, Pt⁴⁺, Pt²⁺, Pt⁺, Cu²⁺, Cu⁺, Ag⁺, Au⁺, Zn²⁺, Cd²⁺, Hg²⁺, Al³⁺, Ga³⁺, In³⁺, Tl³⁺, Si⁴⁺, Si²⁺, Ge⁴⁺, Ge²⁺, Sn⁴⁺, Sn²⁺, Pb⁴⁺, Pb²⁺, As⁵⁺, As³⁺, As⁺, Sb⁵⁺, Sb³⁺, Sb⁺, Bi⁵⁺, Bi³⁺, and Bi⁺.

4. The proton exchange membrane of claim 1, wherein the metal cation is Na⁺.

5. The proton exchange membrane of claim 1, wherein the metal cation is Cs⁺.

6. The proton exchange membrane of claim 1, further comprising a dopant.

7. The proton exchange membrane of claim 6, wherein the dopant comprises one or more compounds selected from an N-heterocycle and an oxoacid.

8. The proton exchange membrane of claim 1, wherein the metal-organic solid contains pores.

9. The proton exchange membrane of claim 14, wherein the pores are from about 3 to about 25 Å.

10. The proton exchange membrane of claim 1, wherein the proton exchange membrane is capable of conducting protons at temperatures from about 25° C. to about 250° C.

11. The proton exchange membrane of claim 1, wherein the metal-organic solid is crystalline.

12. The proton exchange membrane of claim 1, wherein the metal-organic solid further comprises solvent molecules.

13. A proton exchange membrane comprising:
a) a metal-organic solid comprising a salt of:
1) a metal cation and
2) a compound having the formula: 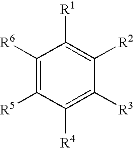
wherein:
R¹, R², R³, R⁴, R⁵, and R⁶ are independently selected from H, OR⁷, NR⁷R⁸, SR⁷, CO₂H, SO₃H, PO₃H₂, PR⁷R⁸, (CH₂)ₙOR⁷, (CH₂)ₙNR⁷R⁸, (CH₂)ₙSR⁷, (CH₂)ₙCO₂H, (CH₂)ₙSO₃H, (CH₂)ₙPO₃H₂, and R⁹, or any two adjacent R groups come together to form a substituted or unsubstituted fused ring;
R⁷ and R⁸ are independently H, C₁-C₁₀ alkyl, C₂-C₁₀ alkenyl, C₂-C₁₀ alkynyl, or aryl;
R⁹ is a compound having the formula: 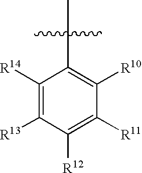
wherein:
R¹⁰, R¹¹, R¹², R¹³, and R¹⁴ are independently selected from H, OR⁷, NR⁷R⁸, SR⁷, CO₂H, SO₃H, PO₃H₂, (CH₂)ₙOR⁷, (CH₂)ₙNR⁷R⁸, (CH₂)ₙSR⁷, (CH₂)ₙCO₂H, (CH₂)ₙSO₃H, (CH₂)ₙPO₃H₂;
n is an integer from 1 to 6;
wherein the compound comprises at least one acidic proton; and
b) a dopant.

14. The proton exchange membrane of claim 13, wherein the metal cation is one or more of the following:
Li⁺, Na⁺, K⁺, Rb⁺, Cs⁺, Mg²⁺, Ca²⁺, Sr²⁺, Ba²⁺, Sc³⁺, Y³⁺, La⁺, Ce⁴⁺, Ce³⁺, Pr³⁺, Nd³⁺, Sm³⁺, Eu³⁺, Gd³⁺, Tb³⁺, Dy³⁺, Ti⁴⁺, Ti³⁺, Zr⁴⁺, Hf⁴⁺, V⁴⁺, V³⁺, V²⁺, Nb³⁺, Ta³⁺, Cr³⁺, Mo³⁺, Mo²⁺, W³⁺, Mn³⁺, Mn²⁺, Re³⁺, Re²⁺, Fe⁴⁺, Fe³⁺, Fe²⁺, Ru³⁺, Ru²⁺, Os³⁺, Os²⁺, Co³⁺, Co²⁺, Rh³⁺, Rh²⁺, Rh⁺, Ir³⁺, Ir²⁺, Ir⁺, Ni²⁺, Ni⁺, Pd²⁺, Pd⁴⁺, Pd⁺, Pt⁴⁺, Pt²⁺, Pt⁺, Cu²⁺, Cu⁺, Ag⁺, Au⁺, Zn²⁺, Cd²⁺, Hg²⁺, Al³⁺, Ga³⁺, In³⁺, Tl³⁺, Si⁴⁺, Si²⁺, Ge⁴⁺, Ge²⁺, Sn⁴⁺, Sn²⁺, Pb⁴⁺, Pb²⁺, As⁵⁺, As³⁺, As⁺, Sb⁵⁺, Sb³⁺, Sb⁺, Bi⁵⁺, Bi³⁺, and Bi⁺.

15. A proton exchange membrane comprising a metal-organic solid comprising a salt of:
a) a metal cation;
b) a compound selected from the group consisting of:

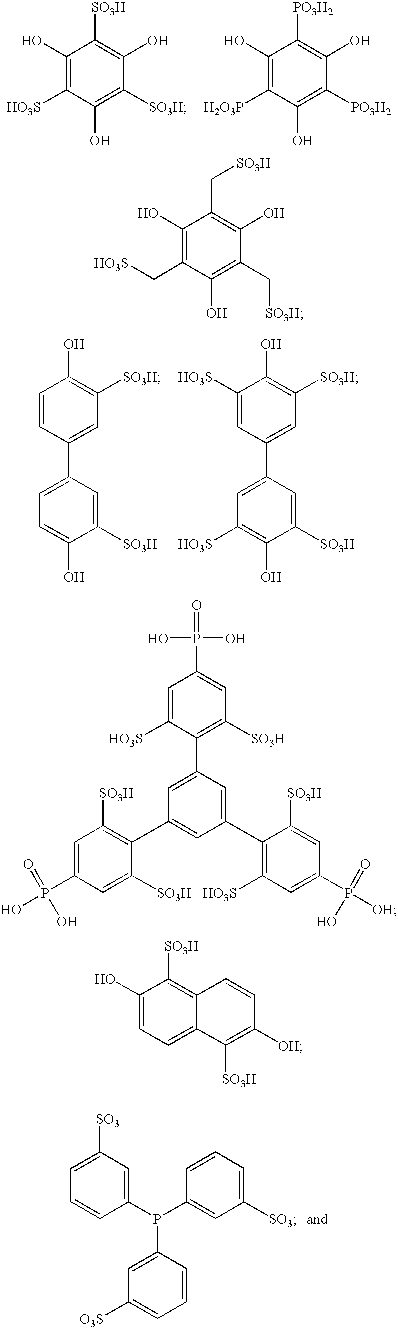

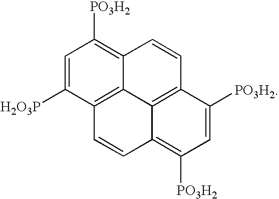

16. A proton exchange membrane comprising a metal-organic solid comprising a salt of:
a) a metal cation;
b) a compound selected from the group consisting of: 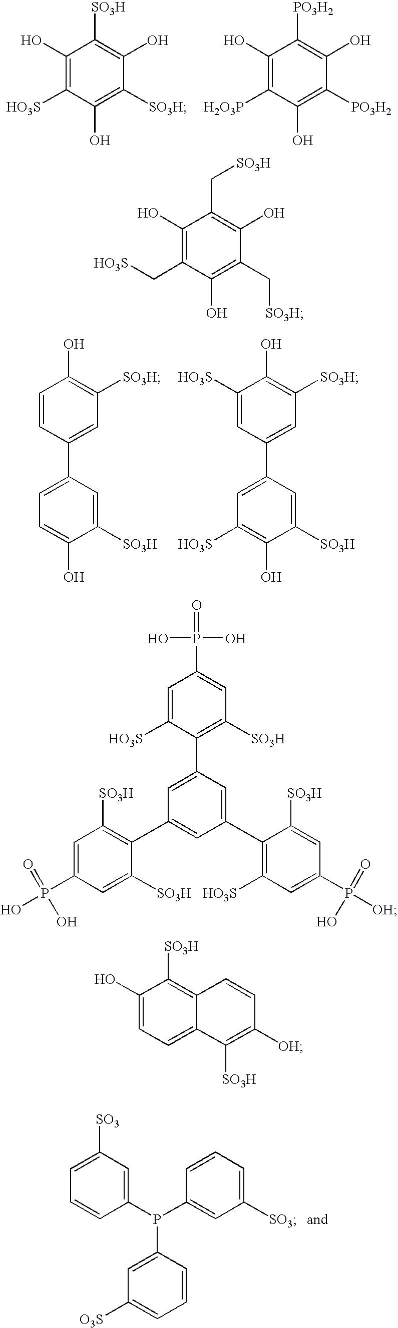 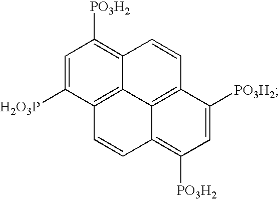
and
c) a dopant.

17. A fuel cell comprising a proton exchange membrane, wherein the proton exchange membrane comprises a metal-organic solid comprising a salt of:
1) a metal cation and
2) a compound having the formula: 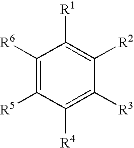
wherein:
R¹, R², R³, R⁴, R⁵, and R⁶ are independently selected from H, OR⁷, NR⁷R⁸, SR⁷, CO₂H, SO₃H, PO₃H₂, PR⁷R⁸, (CH₂)ₙOR⁷, (CH₂)ₙNR⁷R⁸, (CH₂)ₙSR⁷, (CH₂)ₙCO₂H, (CH₂)ₙSO₃H, (CH₂)ₙPO₃H₂, and R⁹, or any two adjacent R groups come together to form a substituted or unsubstituted fused ring;
R⁷ and R⁸ are independently H, C₁-C₁₀ alkyl, C₂-C₁₀ alkenyl, C₂-C₁₀ alkynyl, or aryl;
R⁹ is a compound having the formula: 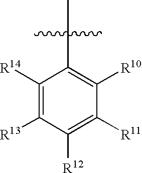
wherein:
R¹⁰, R¹¹, R¹², R¹³, and R¹⁴ are independently selected from H, OR⁷, NR⁷R⁸, SR⁷, CO₂H, SO₃H, PO₃H₂, (CH₂)ₙOR⁷, (CH₂)ₙNR⁷R⁸, (CH₂)ₙSR⁷, (CH₂)ₙCO₂H, (CH₂)ₙSO₃H, (CH₂)ₙPO₃H₂;
n is an integer from 1 to 6; and
wherein the compound comprises at least one acidic proton.

18. The fuel cell of claims 17, wherein the metal cation is one or more of the following:
Li⁺, Na⁺, K⁺, Rb⁺, Cs⁺, Mg²⁺, Ca²⁺, Sr²⁺, Ba²⁺, Sc³⁺, Y³⁺, La³⁺, Ce⁴⁺, C³⁺, Pr³⁺, Nd³⁺, Sm³⁺, Eu³⁺, Gd³⁺, Tb³⁺, Dy³⁺, Ti⁴⁺, Ti³⁺, Zr⁴⁺, Hf⁴⁺, V⁴⁺, V³⁺, V²⁺, Nb³⁺, Ta³⁺, Cr³⁺, Mo³⁺, Mo²⁺, W³⁺, Mn³⁺, Mn²⁺, Re³⁺, Re²⁺, Fe⁴⁺, Fe³⁺, Fe²⁺, Ru³⁺, Ru²⁺, Os³⁺, Os²⁺, Co³⁺, Co²⁺, Rh³⁺, Rh²⁺, Rh⁺, Ir³⁺, Ir²⁺, Ir⁺, Ni²⁺, Ni⁺, Pd²⁺, Pd⁴⁺, Pd⁺, Pt⁴⁺, Pt²⁺, Pt⁺, Cu²⁺, Cu⁺, Ag⁺, Au⁺, Zn²⁺, Cd²⁺, Hg²⁺, Al³⁺, Ga³⁺, In³⁺, Tl³⁺, Si⁴⁺, Si²⁺, Ge⁴⁺, Ge²⁺, Sn⁴⁺, Sn²⁺, Pb⁴⁺, Pb²⁺, As⁵⁺, As³⁺, As⁺, Sb⁵⁺, Sb³⁺, Sb⁺, Bi⁵⁺, Bi³⁺, and Bi⁺.

19. The fuel cell of claim 17, further comprising a dopant.

20. The fuel cell of claim 19, wherein the dopant comprises one or more compounds selected from an N-heterocycle and an oxoacid.

21. The fuel cell of claim 17, wherein the proton exchange membrane is located in a position within the fuel cell wherein the proton exchange membrane is capable of transferring protons from the anode to the cathode.

22. A method for transferring protons from an anode to a cathode in a fuel cell, the method comprising:
a) incorporating into the fuel cell a proton exchange membrane comprising a metal-organic solid comprising a salt of:
1) a metal cation and
2) a compound having the formula: 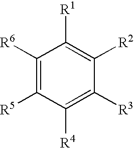
wherein:
R¹, R², R³, R⁴, R⁵, and R⁶ are independently selected from H, OR⁷, NR⁷R⁸, SR⁷, CO₂H, SO₃H, PO₃H₂, PR⁷R⁸, (CH₂)ₙOR⁷, (CH₂)ₙNR⁷R⁸, (CH₂)ₙSR⁷, (CH₂)ₙCO₂H, (CH₂)ₙSO₃H, (CH₂)ₙPO₃H₂, and R⁹, or any two adjacent R groups come together to form a substituted or unsubstituted fused ring;
R⁷ and R⁸ are independently H, C₁-C₁₀ alkyl, C₂-C₁₀ alkenyl, C₂-C₁₀ alkynyl, or aryl;
R⁹ is a compound having the formula: 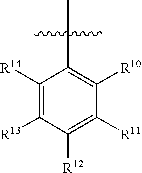
wherein:
R¹⁰, R¹¹, R¹², R¹³, and R¹⁴ are independently selected from H, OR⁷, NR⁷R⁸, SR⁷, CO₂H, SO₃H, PO₃H₂, (CH₂)ₙOR⁷, (CH₂)ₙNR⁷R⁸, (CH₂)ₙSR⁷, (CH₂)ₙCO₂H, (CH₂)ₙSO₃H, (CH₂)ₙPO₃H₂;
n is an integer from 1 to 6; and
wherein the compound comprises at least one acidic proton; and
b) operating the fuel cell.

23. A method for making a fuel cell comprising a proton exchange membrane, the method comprising:
a) providing a proton exchange membrane comprising a metal-organic solid comprising a salt of:
1) a metal cation and
2) a compound having the formula: 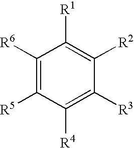
wherein:
R¹, R², R³, R⁴, R⁵, and R⁶ are independently selected from H, OR⁷, NR⁷R⁸, SR⁷, CO₂H, SO₃H, PO₃H₂, PR⁷R⁸, (CH₂)ₙOR⁷, (CH₂)ₙNR⁷R⁸, (CH₂)ₙSR⁷, (CH₂)ₙCO₂H, (CH₂)ₙSO₃H, (CH₂)ₙPO₃H₂, and R⁹, or any two adjacent R groups come together to form a substituted or unsubstituted fused ring;
R⁷ and R⁸ are independently H, C₁-C₁₀ alkyl, C₂-C₁₀ alkenyl, C₂-C₁₀ alkynyl, or aryl;
R⁹ is a compound having the formula: 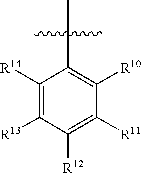
wherein:
R¹⁰, R¹¹, R¹², R¹³, and R¹⁴ are independently selected from H, OR⁷, NR⁷R⁸, SR⁷, CO₂H, SO₃H, PO₃H₂, (CH₂)ₙOR⁷, (CH₂)NR⁷R⁸, (CH₂)ₙSR⁷, (CH₂)ₙCO₂H, (CH₂)ₙSO₃H, (CH₂)ₙPO₃H₂;
n is an integer from 1 to 6;
wherein the compound comprises at least one acidic proton; and
b) locating the proton exchange membrane in a position within the fuel cell wherein the proton exchange membrane is capable of transferring protons from the anode to the cathode.

24. A method for making a proton exchange membrane, the method comprising:
a) providing a compound of the formula: 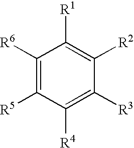
wherein:
R¹, R², R³, R⁴, R⁵, and R⁶ are independently selected from H, OR⁷, NR⁷R⁸, SR⁷, CO₂H, (CH₂)ₙOR⁷, (CH₂)ₙNR⁷R⁸, (CH₂)ₙSR⁷, (CH₂)ₙCO₂H, and R⁹, or any two adjacent R groups come together to form a substituted or unsubstituted fused ring;
R⁷ and R⁸ are independently H, C₁-C₁₀ alkyl, C₂-C₁₀ alkenyl, or C₂-C₁₀ alkynyl;
R⁹ is a compound having the formula: 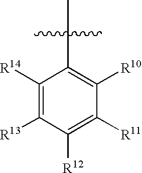
wherein:
R¹⁰, R¹¹, R¹², R¹³, and R¹⁴ are independently selected from H, OR⁷, NR⁷R⁸, SR⁷, CO₂H, (CH₂)ₙOR⁷, (CH₂)ₙNR⁷R⁸, (CH₂)ₙSR⁷, (CH₂)ₙCO₂H; and
n is an integer from 1 to 6;
b) reacting the compound of a) with a halogenated oxoacid; and
c) adding a metal salt to the reaction product of a) and b).

25. The method of claim 24, wherein the metal salt is a metal: carbonate, halide, sulfate, phosphate, oxide, hydroxide, acetate, nitrate, tetrafluoroborate, hexafluorophosphate, organosulfonate, or organophosphonate.

26. The method of claim 24, wherein the halogenated oxoacid is a chlorinated oxoacid.

27. The method of claim 24, wherein prior to step c) a dopant is added to the reaction product of a) and b).

28. The method of claim 27, wherein the dopant comprises an N-heterocycle.

29. The method of claim 24, wherein the method further comprises:
d) adding a dopant to the reaction product of step c).

30. The method of claim 29, wherein the dopant comprises an oxoacid.

31. A proton exchange membrane comprising a metal-organic solid and a dopant, wherein said metal-organic solid contains pores lined with acidic groups.

32. The proton exchange membrane of claim 31, wherein said pores are less than 8 Å in diameter.

33. The proton exchange membrane of claim 31, wherein said dopant is selected from an N-heterocycle or an oxoacid.

34. The proton exchange membrane of claim 31, wherein said dopant is non-volatile.

35. The proton exchange membrane of claim 31, wherein said dopant is a polymer.

36. A proton exchange membrane comprising a metal-organic solid and a polymer.

37. The proton exchange membrane of claim 57, wherein said polymer is a perfluorosulfonic acid polymer.

38. A proton exchange membrane comprising a metal-organic solid comprising a salt of:
1) a metal cation and
2) a compound having the formula: 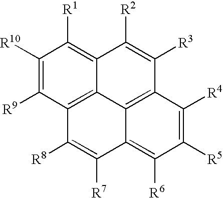
wherein:
R¹, R², R³, R⁴, R⁵, R⁶, R⁷, R⁸, R⁹, and R¹⁰ are independently selected from H, OR¹¹, NR¹¹R¹², SR¹¹, CO₂H, SO₃H, PO₃H₂, PR¹¹R¹²; (CH₂)ₙOR¹¹, (CH₂)ₙNR¹¹R¹², (CH₂)ₙSR¹¹, (CH₂)ₙCO₂H, (CH₂)ₙSO₃H, and (CH₂)ₙPO₃H₂;
R¹¹ and R¹² are independently H, C₁-C₁₀ alkyl, C₂-C₁₀ alkenyl, C₂-C₁₀ alkynyl; or aryl;
n is an integer from 1 to 6; and
the compound comprises at least one acidic proton.

39. The proton exchange membrane of claim 38, wherein R¹-R¹⁰ are independently selected from H, OR⁷, SO₃H, and PO₃H₂.

40. The proton exchange membrane of claim 38, wherein the metal cation is one or more of the following:
Li⁺, Na⁺, K⁺, Rb⁺, Cs⁺, Mg²⁺, Ca²⁺, Sr²⁺, Ba²⁺, Sc³⁺, Y³⁺, La³⁺, Ce⁴⁺, Ce³⁺, Pr³⁺, Nd³⁺, Sm³⁺, Eu³⁺, Gd³⁺, Tb³⁺, Dy³⁺, Ti⁴⁺, Ti³⁺, Zr⁴⁺, Hf⁺, V⁴⁺, V³⁺, V²⁺, Nb³⁺, Ta³⁺, Cr³⁺, Mo³⁺, Mo²⁺, W³⁺, Mn³⁺, Mn²⁺, Re³⁺, Re²⁺, Fe⁴⁺, Fe³⁺, Fe²⁺, Ru³⁺, Ru²⁺, Os³⁺, Os²⁺, Co³⁺, Co²⁺, Rh³⁺, Rh²⁺, Ir³⁺, Ir⁺, Ir⁺, Ni²⁺, Ni⁺, Pd²⁺, Pd⁴⁺, Pd⁺, Pt⁴⁺, Pt²⁺, Pt⁺, Cu²⁺, Cu⁺, Ag⁺, Au⁺, Zn²⁺, Cd²⁺, Hg²⁺, Al³⁺, Ga³⁺, In³⁺, Tl³⁺, Si⁴⁺, Si²⁺, Ge⁴⁺, Ge²⁺, Sn⁺, Sn²⁺, Pb⁴⁺, Pb²⁺, As⁵⁺, As³⁺, As⁺, Sb⁵⁺, Sb³⁺, Sb⁺, Bi⁵⁺, Bi³⁺, and Bi⁺.

41. The proton exchange membrane of claim 38, wherein the metal cation is Na⁺.

42. The proton exchange membrane of claim 38, wherein the metal cation is Cs⁺.

43. The proton exchange membrane of claim 38, further comprising a dopant.

44. The proton exchange membrane of claim 43, wherein the dopant comprises one or more compounds selected from an N-heterocycle and an oxoacid.

45. The proton exchange membrane of claim 38, wherein the metal-organic solid contains pores.

46. The proton exchange membrane of claim 38, wherein the proton exchange membrane is capable of conducting protons at temperatures from about 25° C. to about 250° C.

47. The proton exchange membrane of claim 46, wherein the proton exchange membrane is capable of conducting protons at temperatures from about 100° C. to about 150° C.

48. The proton exchange membrane of claim 38, wherein the metal-organic solid is crystalline.

49. The proton exchange membrane of claim 38, wherein the metal-organic solid further comprises solvent molecules.
